(19) United States
(12) Patent Application Publication
(10) Pub. No.: US 2002/0032582 A1
(43) Pub. Date: Mar. 14, 2002

(54) System for medication dispensing and integrated data management

(76) Inventors: Robert J. Feeney JR., La Jolla, CA (US); Kenneth A. Coons, La Mesa, CA (US); Jennie L. Smith, Carlsbad, CA (US); Thomas E. Radziminski, San Diego, CA (US); Scott B. Bechtler-Levin, Leucadia, CA (US); Minh C. Tran, San Diego, CA (US); Paul F. Cattaneo, La Costa, CA (US); Michael J. Williamson, Carlsbad, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/930,599

(22) Filed: Aug. 15, 2001

Related U.S. Application Data
(60) Provisional application No. 60/232,643, filed on Sep. 14, 2000.

(51) Int. Cl. B65H 1/00; G07F 11/00; G06F 17/60; G06F 17/00

(52) U.S. Cl. 705/2; 700/231; 700/240; 221/1

(57) ABSTRACT

A system for dispensing medication and integrated data management which can include a medical office system with at least one computer which can be linked to at least one server and a central system through a network. The medical office computer also can communicate with at least one controlled dispenser unit, thereby regulating the dispensing of medication. Information pertaining to patients and/or medications can be transmitted and received by each system component.

### RELATED APPLICATIONS

This applications claims priority from U.S. Provisional Patent Application Ser. No. 60/232,643, filed Sep. 14, 2000, the disclosure of which is incorporated herein by reference in its entirety.

### BACKGROUND OF THE INVENTION

1. Field of the Invention

The present invention relates generally to the field of automated and semiautomated data collection and data management services. In particular, the present invention relates to a computerized system to collect and process data regarding the dispensing of medications that are commonly used or prescribed by physicians, and to provide the processed information to interested parties. Further, the present invention also involves inventory management services, where not only data, but actual inventory of medications and supplies can be managed.

2. Description of the Related Art

Prescription Dispensing Procedure

Current prescription filling methods and processes are inadequate and inefficient. First, an authorized caregiver, usually a doctor, writes a prescription on a pre-printed prescription pad. The patient selects a retail pharmacy, usually based upon insurance coverage, and presents the handwritten prescription for filling. The pharmacy puts the prescription into a preparation queue and when the prescription reaches the top of the queue, the pharmacy enters the prescription into its own records or system. If necessary, the pharmacy personnel place calls (callbacks) to the medical office to clarify or notify MD of issues or questions. Some of the reasons for these callbacks are: clinical issues, quantity issues or recommend medication change (these examples are not conclusive). The pharmacy selects the prescription medication according to prescription benefits manager (PBM) guidelines. The prescription is taken from stock within the pharmacy, prepared, bottled and labeled. The patient receives the medication and required counseling from the pharmacist. The patient then pays a co-pay if required. The pharmacy retains the details of the prescription for refilling.

Various attempts have been made to overcome the drawbacks of the traditional prescription filling method. However, the new procedures still lack efficiency and adequate features. These programs are either non-automated or require significant pharmacy approvals.

Sampling Procedure

Sample medications in today's medical office play an important role in the delivery of efficient and effective medication therapy. Pharmaceutical companies spend large portions of launch budgets and promotional budgets on sample programs to build brand awareness and attempt to capture long-term therapies. For the patient, sample medication programs allow patients to immediately begin a course of therapy, ensures patient tolerance of medication prior to prescription fulfillment, provides medication therapy to the indigent, and provides non-insurance covered medications to patients.

Sample medications differ from the prescription medications by packaging, length of therapy and exclusion of pharmacist review prior to dispensing. In many instances physicians give patients more than a “normal” trial amount and instead dispense a full course or monthly quantity. Physicians allocate space in their cramped office for samples based on their desire to “test” medication therapy prior to writing a script and to increase patient satisfaction. Physicians enjoy giving a “free” service to their patients.

The details of sample medication dispensing vary from office to office; however, most medical office dispensing procedures have common elements. Generally, samples are stored in locked cabinets in multiple areas throughout the medical office. Cabinets are usually unlocked in the morning and remain unlocked throughout the business day for easy, rapid access. Physicians are the primary dispensers of sample medications. Typically, the physician pulls samples after examining the patient and delivers the samples to the patient before they leave the examination room. However, there are times that the nurse or medical assistant (RN/MA) will pull the sample from inventory and deliver the item(s) to the patient. Typically, the RN/MA reorders samples from the pharmaceutical representative when the inventory is low or depleted. In addition, RN/MA's often perform the physical restocking of the sample locations. Since samples are medications, medical offices are expected to comply with regulations which mandate that patient name and drug information, such as lot number and expiration date for the sample, be captured in a logbook. Moreover, the physician must sign a replenishment voucher when a pharmaceutical representative restocks their sample inventory.

The pharmaceutical representative is responsible for delivering sample medications (in-person or drop shipped). Normal business flow for the pharmaceutical representative requires two trips from their car into the medical office. During the initial visit, the pharmaceutical representative takes an inventory of the office's sample stock. After determining what samples a particular medical office requires, the pharmaceutical representative returns to the car to grab the samples. In some cases the, the medical office allows the pharmaceutical representative to restock the sample cabinets. Before leaving the medical office, the pharmaceutical representative must obtain a signature for the sample medications that were replenished. During the act of signing the sample replenishment voucher, the pharmaceutical representative details the physician on some of the latest information regarding their company and/or product(s). Usually the physician is focused on signing the paperwork and not receiving the information, so much of the information is missed.

In light of the substantial amounts spent by pharmaceutical companies in order to maintain sample programs, it is of utmost importance for these companies to gain access to medical offices for purposes of physician detailing and sample program monitoring. Many times physicians determine medication therapies based on sample availability. Physicians begin to build brand recognition and loyalty to certain medications as their patients benefit from the therapy. For this reason pharmaceutical companies strive to keep their samples in the medical office, always in stock and target those physicians that sample and prescribe their company's medication(s).

One of the problems facing pharmaceutical companies is the fact that they do not know specifically which physician within an office is sampling their medications so they cannot target appropriately. Even the most successful current sample programs only provide the pharmaceutical representative with general information regarding physician office sample usage. Pharmaceutical companies have long felt a need for data that describes sample medication usage patterns of individual physicians. Such information would allow pharmaceutical representatives to target the appropriate physicians and hope to drive increased prescription writing for those medications.

In addition to these custom sample usage profiles, pharmaceutical companies require an effective means of tracking inventory. An accurate knowledge of medical office sample inventory levels enhance the efficiency of pharmaceutical representatives by allowing them to make informed decisions regarding the appropriate timing of medical office visits and the necessary quantities of appropriate sample medications required for restocking.

Marketing and Information Pushing

Current drug dispenser systems predominantly have a one way data flow because both information automatically collected by the system and that entered by the user is compiled and provided back to the medical office or hospital staff. These systems do not provide interested outside parties with access to data regarding the medication dispensing patterns of individual physicians. As a result, targeted data flow to the medical office from outside parties is not available.

OTC Items and Patient Care Items

Providing the patient with specific over-the-counter (OTC) medications and cosmeceuticals is an important aspect of some medical specialty services. These specialties provide such services for patient satisfaction as well as revenue opportunities for the medical office. Because limited security is required to dispense OTC medications and cosmeceuticals, often times dispensing occurs at the front desk with the clerk. Due to this dispensing flexibility and the high cost of these items, most physician offices have purchased or developed ways of tracking inventory and reconciling accounts.

In most medical offices, there exists those items that are consumed within the office, such as, vaccines, other injectables, and durable medical equipment (DME's). These items are referred to as patient care items. In most instances, patient care items are managed by the clinical office staff and are generally kept in the back office (many times refrigerated). Patient care items typically do not require a prescription, but do require the physician's request and ICD-9 to ensure proper reimbursement.

Most patient care items fall under major medical or PBM insurance and require certain billing and ordering requirements for proper transaction processing. There is often a struggle between major medical carriers and PBM carriers regarding coverage and reimbursement for many patient care items. If the item falls under major medical the patient does not incur direct payment responsibility (unless the patient is covered by a fee for service plan). However, if the item falls under PBM coverage, the patient is responsible for the appropriate co-pay.

As with OTC medications and cosmeceuticals, patient care items represent a significant fraction of the retail side of a physician's practice. Correspondingly, each office has a means of keeping inventory and ensuring that payment is received for these items.

Current medication dispensing systems focus on tracking only the dispensing of prescription medications. Part of the reason for this focus is due to single service, segregated nature of these dispensing systems. Even though a medical office might be equipped with a prescription drug dispenser which collects data regarding the dispensing of prescription medications, the dispensing of non-prescribed medications is still tracked using the traditional in-office inventory accounting system.

For all of the items mentioned herein, there are conditions in which individual parties operating together in a common space need to keep the ownership, accounting, and management of products stored and dispensed separate. The need for separate management may arise from, among other things, regulatory needs, business practices, and security issues. The scarcity of available space in some of these environments can prohibit the deployment of individual automated inventory control and dispensing systems for each party. The amount of space required by individual systems can increase by as much as 100% per party in the worst case. It is therefore desirable to be able to take advantage of shared storage space, yet maintain the individual control, management, and accounting of inventory movement.

### SUMMARY OF THE INVENTION

The invention is generally directed to systems and methods for medical product dispensing and integrated information distribution and business management. In one aspect the present system relates to a medical system for integrating data management with the process of controllably dispensing products including medications. The medical system can include one or more dispensers configured to controllably release a product in response to a control signal. The medical system can include an admission subsystem configured to maintain patient information, and a prescription subsystem coupled to the one or more dispensers. The prescription subsystem can be configured to receive entry of prescription information. The subsystem can be configured to relate patient information from the admission subsystem to the prescription information to initiate a determination of whether the product is appropriate for the patient. The subsystem can be configured to send a control signal to the one or more dispenser units to release the product. The above mentioned determination of whether the medication is appropriate for the patient can include a pharmacy adjudication. Also, the determination of whether the medication is appropriate for the patient can include a drug utilization review (DUR).

The prescription subsystem further can be configured to manage and control a virtual inventory by tracking ownership and utilization of a plurality of individually owned and co-mingled inventories in the one or more dispensers. The prescription subsystem can be configured so that access to a medication in inventory further can be controlled according to ownership of the medication as tracked in the virtual inventory. The prescription subsystem can be configured to manage and control a physical inventory by sending a reorder message to reorder a product when an inventory level is at a predefined level. The predefined level can include a par inventory level. The predefined level can include a dynamic par level that is based upon medical office product usage data. The admission subsystem can generate a patient specific drug benefit profile used in prescribing the medication.

The medical system further can include a sample management subsystem configured to track the distribution of a sample medication to a patient. The sample management subsystem also can be configured to associate information gathered from the distribution of the sample medication with the patient information, and to initiate a determination of whether the medication is appropriate for the patient. Further, the sample management subsystem can be configured to send a control signal to said one or more dispenser units to release a sample medication.

The medical system further can include a patient care subsystem configured to relate the patient information to data collected from the dispensing of an office administered medication. The patient care subsystem can be configured to send a control signal to the one or more dispenser units to release the office administered medication. The medical system further can include an over-the-counter subsystem configured to relate the patient information to data collected from the dispensing of an over the counter product. Also, it can be configured to send a control signal to the one or more dispenser units to release the over the counter product. The medical system can dispense the medications or products at the point of care, for example.

The medical system further can include a central server connected via a network to the prescription subsystem. The central server can be configured to receive and process the determination of whether the medication is appropriate for the patient. The central server can be coupled to an enterprise resource planning system (ERP). The ERP can have, for example, an accounting module configured to track finances and collection of money, an inventory module configured to manage physical and virtual product inventories, a purchasing module configured to automatically process purchase requests, a fulfillment module configured to manage product order requests, and the like.

Another aspect of the present system relates to a medical product dispensing system for integrating data management with the process of controllably dispensing medical products at the point of care. The medical product dispensing system can include one or more dispensers configured to controllably grant access to a product in response to a control signal and an admission subsystem configured to collect and maintain patient information. Also, the medical product dispensing system can include a prescription subsystem for receiving entry of prescription information. Also, for relating patient information from the admission subsystem to the prescription information to initiate a determination of whether the medication is appropriate for the patient. Further, for sending a control signal to said one or more dispenser units to release a product. The medical product dispensing system can include a sample management subsystem configured to track the distribution of a sample medication to a patient and to associate information gathered from the distribution of the sample medication with the patient information to initiate a determination of whether the sample medication is appropriate for the patient. The sample medication subsystem can be configured to send a control signal to said one or more dispenser units to grant access to the sample medication. Further, the medical product dispensing system can include a marketing subsystem configured to associate the patient information with the information from at least one other subsystem, thereby determining appropriate marketing information to transmit. The medical product dispensing system can include a point of sale subsystem configured to manage payment information.

The sample management subsystem of the medical product dispensing system further can be configured to relate patient information from the admission subsystem to the prescription information. The sample management subsystem can be configured to initiate a drug utilization review (DUR) to determine whether the sample medication is appropriate for the patient.

The medical product dispensing system further can include a central server connected via a network to the prescription subsystem, said sample management subsystem, said marketing subsystems, and the like. The central server can be further configured to receive and process the determination of whether the medication is appropriate for the patient. The central server can be configured to receive and process a drug utilization review (DUR). The central server can be configured to maintain data and/or information in a database. The central server can be coupled to an information distribution subsystem that can be configured to generate and display reports from the data and/or information to users. The medical product dispensing system farther can include physical and virtual inventory control and management.

The present system in one aspect relates to a medication dispenser for integrating data management with the process of controllably dispensing a product at the point of care. The medication dispenser can include one or more product cabinets configured to controllably release a product in response to a control signal from a prescription subsystem and an admission subsystem configured to collect patient information. The medication dispenser further can include a prescription subsystem configured to receive entry of prescription information. The subsystem also can be configured to relate the patient information to the prescription information to initiate a determination of whether the product is appropriate for the patient. Further, the subsystem can be configured to transmit a control signal to the one or more product cabinets to permit access to the product.

The medication dispenser further can include a marketing subsystem configured to track and report use of the product. Also, the marketing subsystem can be configured to associate the patient information with the use of the product thereby determining appropriate marketing information to direct to an individual dispensing the product and/or the patient.

Also, an aspect of the present system relates to a system for integrating data management with the process of dispensing a sample medication. This system can include one or more dispensers configured to controllably release a sample medication in response to a control signal from a sample management subsystem and an admission subsystem configured to collect patient information. The system can include a sample management subsystem configured to determine a sample medication for a patient and to track sample medication usage. The subsystem further can be configured to transmit a dispense signal to the one or more dispenser units.

The sample management subsystem further can be configured to initiate a drug utilization review (DUR) of the sample medication prior to transmitting a dispense signal to the one or more dispenser units. The sample management subsystem also can be configured to track dispensing of the sample medication and to compile and to provide sample usage reports to a user.

The system for integrating data management with the process of dispensing a sample medication further can include a marketing subsystem configured to track and report the use of the sample medication. The marketing subsystem also can be configured to associate the patient information with the use of the sample medication thereby determining appropriate marketing and educational information to direct to an individual dispensing the sample medication and/or the patient. The system for integrating data management with the process of dispensing a sample medication can include a central server connected via a network to the sample management subsystem. The central server can receive tracked sample medication usage information from the sample management subsystem. The central server can make the sample management usage information available to an authorized user. For example, the authorized user can be a pharmaceutical company representative, or other like entity. Also, the authorized user can be a medication supplier, for example or any other like entity.

A further aspect of the present system relates to a system for integrating data management with the process of dispensing products at the point of care. The system can include a patient information database configured to maintain patient information and one or more dispensers configured to dispense a product in response to a control signal from a prescription module. The system also can include a prescription module to receive a prescription for the product and to initiate an adjudication check for the product utilizing the patient information. The prescription module further can be configured to transmit the control signal to the one or more dispensers to release the product.

The system for integrating data management with the process of dispensing products at the point of care can further include an inventory management module to control and manage the inventory of the product. The prescription module further can manage and can control a virtual inventory by tracking ownership and utilization of a plurality of individually owned but co-mingled inventories in the one or more dispensers. The product can be released to a user in response to the control signal based upon the user having product in virtual inventory.

An aspect of the present system relates to a system for integrating data management with the process of controllably dispensing products at the point of care. The system can include a patient information database configured to maintain patient information and one or more dispensers configured to controllably dispense a product in response to a control signal from a prescription module. The system also can include a prescription module to receive a prescription for the product and to initiate an adjudication check for the product utilizing the patient information. The prescription module further can transmit the control signal to the one or more dispensers to release the product. The system further can include an inventory management module to control and manage the inventory of the product. The inventory management module can be configured to control and manage a physical inventory and a virtual inventory for the product. The inventory management module can be configured to manage and control the virtual inventory by tracking ownership and utilization of a plurality of individually owned and co-mingled product inventories in the one or more dispensers. Access to a product in inventory further can be controlled according to ownership of the product as tracked in the virtual inventory. Also, the inventory management module can be configured to manage and control a physical inventory by sending a reorder message to reorder a product when an inventory level is at a predefined level. The predefined level can include a par inventory level. The predefined level can include a dynamic par level that is based upon medical office product usage, for example. The system further can include a central server connected via a network to the inventory management module. The central server can be connected to an ERP subsystem that is configured to receive and process the reorder message.

A further aspect of the present system relates to a system for dispensing a medical product and for controlling a virtual inventory. The system can include one or more dispensers to controllably release a medical product in response to a control signal. The system can include a prescription subsystem. The prescription subsystem can be configured to manage and control a co-mingled physical inventory of a plurality of individually owned medical products. The prescription subsystem also can be configured to send a dispense signal to the one or more dispensers to release a medical product to a user based upon the user having the medical product in a virtual inventory.

Another aspect relates to a medical system for integrating data management with the process of controllably dispensing a product, including a medication. The medical system can include one or more dispensers configured to controllably release a product in response to a control signal. The medical system can include an admission subsystem configured to maintain patient information. The medical system also can include a prescription subsystem coupled to the one or more dispensers. The prescription subsystem can be configured to receive prescription information, to relate patient information from the admission subsystem to the prescription information, to initiate a pharmacy adjudication request, and to send a control signal to the one or more dispenser units to release a product. Further, the medical system can include a central system that includes a central server connected via a network to the prescription subsystem. The central server can be configured to receive and process the pharmacy adjudication request. The central system can include an enterprise resource planning subsystem coupled to the central server. The enterprise resource planning (ERP) subsystem can have an accounting module configured to track finances and collection of money, an inventory module configured to manage physical and virtual product inventories, a purchasing module configured to automatically process purchase requests, a fulfillment module configured to manage product order requests, and other like modules. The central system can include a pharmacy subsystem. The pharmacy system can be configured to adjudicate a pharmacy adjudication request. The central system can include a support subsystem connected to the central server. The support subsystem can be configured to manage and control user training and learning modules. The central system can include a website connected to the central server. The website can be configured to provide controlled user access to system information. The system information is can include a financial report, an inventory report, a usage report, a regulatory report, a sales reports, an order management report, a business report, and the like. The system further can include a front office server configured to serve patient information. The front office server can be coupled to the one or more dispensers and include the admission subsystem and the prescription subsystem. The central server can be configured to provide content to a marketing subsystem. The central system can perform system maintenance, monitoring, and the like.

Another aspect relates to a method for dispensing a medical product at the point of care. The method can include receiving a prescription request for a medical product for a patient. The method also can include transmitting the prescription request for adjudication by comparing patient information with prescription information for the medical product to determine whether the medical product is appropriate for the patient. Further, the method can include releasing the medical product from a controlled dispenser and sensing removal of the medical product from the controlled dispenser. The method further can include verifying that the correct medical product is taken. The method further can include manually sending refill information to a pharmacy, medical product supplier, and/or the like. The method also can include electronically sending refill information to a pharmacy, medical product supplier, and/or the like.

A method for controllably dispensing a medication and integrating data management. The method can include receiving a prescription for a medication. Also, initiating an adjudication check that can include comparing patient information with prescription information for the medication to determine whether the medication is appropriate for the patient. The method further can include providing clinical or marketing information related to the prescription to a user or the patient, and making the medication available to the user. Further it can include sensing the taking of the medication and verifying that the correct medication is dispensed. Sensing the taking can include electronically sensing the taking of the medication. Verifying that the correct medication is taken can include receiving medication package information and comparing the medication package information to stored information on the system. The medication information can be received by scanning a bar code on the medication package.

Another aspect relates to a method for dispensing a medical product and integrating data management. The method can include receiving a request for a medical product, and providing clinical or marketing information related to the request to a user or a patient. The method also can include making the medical product available to the user. Further, it can include sensing the taking of the medical product from a controlled dispenser and verifying that the correct medical product is taken from the controlled dispenser. The method further can include initiating an adjudication check. The adjudication check can include comparing patient information with request information for the medical product to determine whether the medical product is appropriate for the patient.

Also, an aspect relates to a method for inventory management and control of a plurality of individually owned product that is co-mingled in a controlled dispenser unit. The method can include storing in a controlled dispenser unit a plurality of individually owned product for more than one inventory owner. Also, receiving inventory data for each individual inventory owner, and tracking the dispensing of a product owned by the individual inventory owner from the controlled dispenser unit. Further, the method can include updating the inventory data, and controllably dispensing the product based upon the inventory data for the individual inventory owner.

A further aspect relates to a method for controlling access to a plurality of individually owned product that is co-mingled based upon virtual inventory. The method can include storing together in a controlled dispenser a plurality of individually owned product for more than one inventory owner. It can also include tracking the inventory level of the individually owned product for each inventory owner. Further, the method can include granting access to an individual inventory owner to a product based upon the inventory level of the individual inventory owner.

Another aspect relates to a method for providing information used in prescribing a medication at the point of care using a patient specific drug benefit profile. The method can include generating a patient specific benefit profile integrating patient specific information, benefit profile, inventory status, and the like, for example. The method also can include displaying said patient specific benefit profile to a user. The patient specific drug benefit profile can be displayed on a handheld computer, a printout, a desktop computer, a laptop computer and the like.

Prescription

The present system can provide various services for the physicians. First, inventory control. In order for a physician to have a successful dispensing program, they must be involved in the ordering, receiving, and tracking aspects of the inventory. The present system provides hardware and software to make this process as easy for the physician staff as possible. The cabinetry, software control and item packaging can be combined to create an easy to use system for inventory control.

The present system addresses a limitation of automated inventory storage and dispensing systems, not only for prescription items, but also for any of the items listed herein and other like items. Current medical office automated inventory systems do not provide for the management and tracking of products that are individually owned by more than one party, but stored together in a common unit. The present invention provides a system and method for managing, controlling, and maintaining the inventory of separately owned, but commonly stored products, while complying with any necessary regulations. Where each participating party owns some quantity of products that are stored within the facility, then current amounts owned by each party are recorded separately from quantities of product stored in particular storage locations.

Claims adjudication is another service that our product will provide. Using the prescribe worksheet or patient benefit profile, the physician can make a more informed decision about how affordable a particular therapy is for a patient. Also, prescription subsystem can provide the physician with clinical information, such as drug utilization review (DUR) information at the time the therapy or medication decision is made. Then, the service provides all of the connectivity requirements for linking to insurance claim processors (PBM) and credit card sources.

The present system can finalize claim adjudication in real time. This system achieves real time adjudication because it is always in contact with multiple PBM switches that are available on a continuous basis. Moreover, the system can provide a protocol for routing claim exceptions to qualified staff members for rapid resolution.

Real time adjudication provides both the physician and the patient with valuable information when deciding which medication most appropriate. First, real time adjudication provides the physician with a guarantee that she will receive full payment for the medication at the time of dispensing. Additionally, real time adjudication provides the patient with the assurance that the medication is covered under his insurance plan.

Further, the present invention can include clinical systems. The kiosk can provide access to drug related information for items prescribe by the office. In addition, clinical tools for aiding in the detection of various drug interactions can be provided. Finally, policies, procedures and various reports can be provided to ensure an office meets or exceeds the various regulatory requirements for a physician dispensing medications.

The system can also include a complete financial management system. The system can provide extended terms for the purchase of medications, a complete bookkeeping service for all transaction performed by the system and a monthly statement of the monies processed by the medical office for the drugs contained within the system.

Sampling

The present system allows the medical office to comply with all regulations regarding the dispensing of sample medications without creating an increase in the workload of any of the office staff. The system automatically can update the electronic sample log with patient information and relevant data regarding the sample medication. The system can be configured so that the physician need only enter the lot number and expiration date of the dispensed medication to be in regulatory compliance.

The present system also can collect, process and make available to pharmaceutical companies, via a remote web browser, or an email accurate and up-to-the-minute data regarding the sample medication dispensing practices of individual physicians, results of detailing efforts and current medical office sample inventory. This method of data collection, processing and presentation greatly increases the work efficiency of pharmaceutical representatives and provides pharmaceutical companies with information that was rarely obtainable previously.

Marketing

The present system provides the medical office with a data stream by which sources, such as pharmaceutical companies and other interested entities, can target product promotions to patients of specific physicians by transmitting electronic coupons to the point of dispensing. Additionally, the present system provides a mechanism by which drug and other companies can present specifically targeted product and educational information to interested physicians and office staff. Using the data collected from the sampling programs and prescription dispensing programs, the system can target product information to only interested physicians. Because the product information or links to the relevant information can be delivered via the Internet and can be stored on the medical office server, interested physicians and staff can access the information at times most convenient for them.

The present system also enables drug companies and other entities to obtain critical information directly from physicians and other office staff in the form of drug usage surveys. These surveys can be either voluntary or mandatory.

OTC, Patient Care and Other Retail Items

The system disclosed herein fully integrates data collection regarding the dispensing of the physician's entire stock of retail items, including over-the-counter (OTC), patient care (OAM), and other retail items. Separate subsystems are used to collect data regarding the dispensing of prescription drugs, sample medications, OTC drugs, narcotics and patient care items. The system can achieve integration by feeding data collected from these class specific dispensing subsystems to a central data processing unit that is capable of using this information to generate financial, inventory management, regulatory and other like reports. Through the use of this system, the physician can monitor every facet of retail business by using a single automated system.

### BRIEF DESCRIPTION OF THE DRAWINGS

This invention may be more clearly understood from the following detailed description and by reference to the drawings in which:

FIG. 1 is a representation of a system for medication dispensing and integrated data management.

FIG. 2 is a functional block diagram of the medical office system and the central system.

FIG. 3 is a functional block diagram of the subsystems of the medical office system.

FIG. 4 is a task flow diagram of the admission subsystem.

FIG. 5 is a task flow diagram of the generation of a prescribe worksheet.

FIG. 6 is an exemplary prescribe worksheet.

FIG. 7 is a task flow diagram of the prescription input process.

FIG. 8A is a task flow diagram of one possible prescription medication dispensing process.

FIG. 8B is a task flow diagram of one possible prescription medication dispensing process.

FIG. 9 is a task flow diagram of the prescription subsystem medication return process.

FIG. 10 is a task flow diagram of the process eliminating expired medications.

FIG. 11 is a task flow diagram of the medication restocking process.

FIG. 12 is a task flow diagram of the inventory process.

FIG. 13 is a task flow diagram of the process for eliminating expired medications.

FIG. 14 is a task flow diagram of the process for reordering medications.

FIG. 15 is a task flow diagram of the process for selecting new medications for inventory tracking.

FIG. 16 is a task flow diagram of the process for loading a medication into the dispenser.

FIG. 17 is a task flow diagram of the process for unloading medications from a dispenser.

FIG. 18 is a task flow diagram of the process for recalling specific lots of medications.

FIG. 19 is a task flow diagram of the sample dispensing process.

FIG. 20 is a representation of the marketing subsystem.

FIG. 21 is a task flow diagram of the marketing subsystem e-coupon process.

FIG. 22 is a task flow diagram of the marketing subsystem e-detailing, advertising and survey process.

FIG. 23 is a task flow diagram of the point-of-sale check out process.

FIG. 24 is a task flow diagram of the point-of-sale credit return process.

### DETAILED DESCRIPTION OF THE PREFERRED EMBODIMENT

Definitions

As used herein, “adjudication” means the act of checking to see if a PBM will pay the physician for dispensing a medication to a particular patient. Such authorization determines the patient's status with the insurance company, whether the medication is on formulary (covered by the patient's insurance plan), and whether limitations are associated with the medication.

As used herein, “AWP” means the Average Wholesale Price. The AWP represents the price that a manufacturer suggests that the wholesaler charge pharmacies. Most pharmacies determine the retail price as a percentage of the AWP, i.e. AWP plus 10%.

As used herein, “brand name” medications are those that are specific to a manufacturer. Brand name medications can only be purchased from the manufacturer owning the brand name.

As used herein, “central server” means a server that is connected to each front office server via the Internet. The central server may also communicate or be physically linked to other servers and/or computer systems or subsystems.

As used herein, “chart note” means a note placed in the patient chart for future reference. It indicates medication prescribed, sample given and any other clinical information that is useful for future reference.

As used herein, “chief complaint” means the primary reason the patient cites when making an appointment with the physician.

As used herein, “clerk” means the person at the front desk that handles patient check-in, co pay, appointment scheduling and other like tasks.

As used herein, “controlled substance” means any medication with a high potential for abuse. The DEA strictly monitors that use of controlled substances. Controlled substances fall into a hierarchy of classes numbered I-V.

As used herein, “co-pay” means the specified dollar amount that a patient is required to pay to cover his/her portion of the cost for either an office visit or medication cost.

As used herein, “counseling consent” refers to a means by which a patient waives required clinical counseling that is provided at the time the medication is dispensed. Patients must sign a waiver if they decline counseling for their new prescription(s).

As used herein, “CPT-4” means Current Procedural Terminology version 4. CPT-4 is used to identify a certain regimen of therapy.

As used herein, “DEA” means the Drug Enforcement Administration. The DEA is the agency responsible for enforcing compliance with the regulations regarding the manufacture, possession, sale and use of Class I-V medications.

As used herein, “DEA number” refers to the registration number provided to physicians that are registered by the DEA to prescribe controlled substances.

As used herein, “detailing” refers to the process by which physicians receive information regarding a pharmaceutical company's product(s). Traditionally, a pharmaceutical representative provides all of this information while the physician is signing for sample medications or during a breakfast or lunch appointment.

As used herein, “discrepancy” means an inventory error that requires user input for reconciliation and/or resolution.

As used herein, “dispense” means to prepare and give out medications or the act of removing medications from the system for patient delivery and/or use.

As used herein, “dispensing consent” means written consent provided by the patient which identifies the physician's dispensing service as one option to the patient. Patient must provide a written acknowledgment that s/he is aware of the other dispensing options.

As used herein, “DME” means durable medical equipment and includes items, such as, splints, braces, and crutches.

As used herein, “dosage” means the administration of a therapeutic agent in prescribed amounts.

As used herein, “drop ship” means to ship directly from a repackager, wholesaler or manufacturer to medical office.

As used herein, “drug history” refers to a listing or profile of all medications the patient is currently taking or has previously taken. A synonymous term is drug profile.

As used herein, “drug monograph” refers to detailed information regarding a drug's interactions, dosing, administration, classification, adverse effects and other like information.

As used herein, “DUR” means drug utilization review. The DUR is a formal review process for assessing prescription medications against some standard. The DUR considers clinical appropriateness, cost effectiveness, and in some cases, outcomes. Review normally occurs before medications are dispensed; however, it may also occur subsequent to the dispensing of medication. Some pharmacy benefit managers require that a DUR be performed.

As used herein, “EOQ” means economic order quantity. EOQ represents the number of units to order any one particular time in order to reduce the total expected annual costs of an inventory system.

As used herein, “eCoupon” means electronic coupons. Electronic coupons are promotional offers related to the prescribed or other medications which are provided to the patient by a variety of means, such as, a e-mail or printed coupon.

As used herein, “Eprescriber” refers to a handheld electronic device used by physicians for prescription input and routing. An ePrescriber also provides the physician with vital drug information at the point of care.

As used herein, “eVoucher” means an electronic coupon generated by the system that will allow the patient to have their sample filled at another location.

As used herein, “expiration date” refers to the date on which the medication is regarded as no longer chemically potent and has lost its therapeutic effectiveness.

As used herein, “FDA” means the Food and Drug Administration. All adverse drug interactions must be reported to the FDA.

As used herein, “formulary” means the medications approved for use within a prescription program.

As used herein, “front office server” means a server physically residing in the physician office.

As used herein, “generic”=0 means the official name of the medication. More than one manufacturer can produce the same medication with a different brand name, but they will all have the same generic name.

As used herein, “HIPAA” means the Health Insurance Portability and Accountability Act of 1996. This act governs the privacy of electronic medical records.

As used herein, “HMO” means health management organization. An HMO is an organization that a patient contracts with to provide health and possibly prescription coverage.

As used herein, “ICD-9” refers to the International Classification of Disease, version 9. It is used to identify a patient's disease state for insurance reimbursement.

As used herein, “interactive detailing” means audio and/or video detailing where the pharmaceutical representative can interact with the physician remotely. This allows the physician to schedule detailing time that is convenient for them.

As used herein, “Internet” refers to a network or combination of networks spanning any geographical area, such as a local area network, wide area network, regional network, national network, and/or global network. As used herein, “Internet” may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communication services (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

As used herein, “IMS” means IMS Health Global services. IMS provides global information services to the pharmaceutical and healthcare industries. Pharmaceutical companies receive prescription and medication information every six to eight weeks from IMS.

As used herein, “JCAHO” means the Joint Commission on Accreditation of Healthcare Organizations. JCAHO is the organization that ensures that specific procedures and guidelines are followed within healthcare organizations.

As used herein, “kiosk” means a network-connected computer or workstation that is capable of receiving and displaying and processing patient and prescription related information. A kiosk may contain hardware in addition to the computer, such as, printers, scanners, cash drawers, card readers, and other like devices.

As used herein, “legend” item means any medication that requires a prescription or an order from a physician. A non-legend item does not require a prescription or physician order.

As used herein, “lot number” is the number assigned by the manufacturer to a specific batch of medication.

As used herein, “MA” means medical assistant. The MA is the person that provides the majority of clinical assistance within the physician office.

As used herein, “network” means the Internet or any other system for facilitating communication between computers or other electronic hardware.

As used herein, “NDC” means national drug code. This code is used to identify the manufacturer, medication, dose form, strength, and package size.

As used herein, “OBRA” means the Omnibus Budget Reconciliation Act. OBRA requires retail pharmacists to counsel patients on new prescriptions.

As used herein, “OSHA” means the Office of Safety and Health Administration.

As used herein, “OTC” means over-the-counter. Over-the-counter medications are those that can be purchased without a prescription. A synonymous term is nonlegend item.

As used herein, “par level” refers to an arbitrary level set by a user or a system to trigger an activity such as refill for inventory control.

As used herein, “patient care items” refer to items used in the physician's office during the patient visit. Also referred to as office administered medications (OAMs), patient care items include items that do not fall into the OTC, sample or prescription categories. Items such as vaccines and braces are patient care items.

As used herein, “patient chart” means a record of a patient's medical history. A patient chart is also referred to as the patient history.

As used herein, “PBM” means pharmacy benefits manager. PBMs are groups that patients contract with to provide prescription coverage.

As used herein, “PBM switch” refers to a location or service that routes the adjudication messages to the appropriate PBM.

As used herein, “PDR” means Physicians' Desk Reference.

As used herein, “PMS” means practice management system. The practice management system is a software package that provides record keeping, accounting and other features useful in the operation of a physician office.

As used herein, “PreScribe Worksheet” means a patient prescribing worksheet. This worksheet is a data entry template for storing vital patient and PBM information and delivering it to the physician, at the point of care. This worksheet is also be used to route prescriptions and can be used to replace ePrescriber type devices.

As used herein, “prescription routing” refers to the act of sending a patient prescription to their pharmacy of choice. Many times this may be an electronic routing or fax routing.

As used herein, “private pay” means that the patient pays the entire bill, either because the insurance company does not pay for the visit, procedure, or medication or the patient does not have insurance.

As used herein, “product” means any item dispensed, tracked, or accounted for by the system. “Product” can include prescription and office administered medications, cosmeceuticals, nutriceuticals, over-the-counter goods, and any other like item.

As used herein, “pull detailing” means a procedure by which the office staff can gain access to archived detailing information of their choice. In addition, staff can request detailing information on medications of interest.

As used herein, “push detailing” means a procedure which allows pharmaceutical companies to present detailing information to targeted specialty segments.

As used herein, “real time adjudication” refers to a process by with claim adjudication is performed prior to the dispensing of a medication. This adjudication process typically takes less than 10 seconds from start to finish.

As used herein, “repackager” refers to a company that breaks down large stock bottles of medication into smaller patient sized quantities.

As used herein, “RN” means a registered nurse.

As used herein, “RPh” refers to a registered pharmacist.

As used herein, “RPhT” refers to a registered pharmacy technician.

As used herein, “PharmD” refers to a doctorate of pharmacy.

As used herein, “sample” means a legend item packaged by a pharmaceutical company in small quantities and distributed without charge.

As used herein, “script” means an abbreviation used in place of prescription.

As used herein, “SFA” means sales force automation system. SFA is used to assist sales teams in pre-call planning, contracting, scheduling, and customer management and customer profiles.

As used herein, “starter dose” means a package of medication that does not deliver the full course of therapy. It is designed to get the patient started on a particular medication.

As used herein, “tele-pharmacist” means a pharmacist that is available on demand via telephone or video. A tele-pharmacist delivers healthcare support to the physician or patient from a remote location.

As used herein, “video detailing” means archived video sessions that the physician can view at her leisure. Pharmaceutical companies can target the video audience and track viewers of the presentation.

As used herein, “WAC” means the wholesaler acquisition cost. WAC represents the actual average price that wholesalers charge pharmacies. Both AWP and WAC can be obtained from the Medispan database.

As used herein, “website” refers to one or more interrelated web page files and other files and programs on one or more web servers, the files and programs being accessible over a computer network, such as the Internet, by sending a hypertext transfer protocol (http) request specifying a uniform resource locator (URL) that identifies the location of one of said web page files, wherein the files and programs are owned, managed or authorized by a single business entity. Such files and programs can include, for example, hypertext markup language (HTML) files, common gateway interface (CGI) files, and Java applications. The web page files preferably include a home page file that corresponds to a home page of the website. The home page can serve as a gateway or access point to the remaining files and programs contained within the website. All of the files and programs can be located under, and accessible within, the same network domain as the home page file. Alternatively, the files and programs can be located and accessible through several different network domains.

System Overview

The present system combines the electronic hardware and software components to create a system of dispensing medication and information at the point-of-service while incorporating data management into the dispensing process. To tightly control dispensing units while providing new data management features, this system can include a number of subsystems with specific functionalities. The subsystems can be implemented by hardware and/or software components. Further, the subsystems can reside on both hardware and software components. Certain functionalities can be unique to a subsystem in some cases but in many cases several subsystems possess identical functionalities. Additionally, subsystems and functionalities can be duplicated on different parts of the system.

Some subsystems can be comprised only of software modules that reside on system hardware. For such subsystems, functionality is primarily provided by the software modules. Other subsystems can be comprised of software modules and specific electronic hardware components. Specific hardware components can include but are not limited to, an apparatus for containing and/or dispensing medication; a computer network; a server; a personal computer, laptop, handheld or equivalent; a dumb terminal; or a combination of these components. The functionalities of such subsystems are provided by both the physical characteristics of the hardware and the software modules that enable it to perform its specific tasks.

The system disclosed herein achieves integration of data management into the drug dispensing process by providing a communication network that allows each of its subsystems to send and receive information. For example, the admission subsystem is responsible for collecting patient information and distributing or making it available to other appropriate subsystems. In one instance, patient information obtained from the admission subsystem is used by the sample management subsystem, which tracks a physician's dispensing of sample medications by patient and provides compiled drug usage and drug inventory reports to pharmaceutical representatives as well as regulatory reports to the physician. In another example, patient information is used by the marketing subsystem to allow entities, such as, pharmaceutical companies, disease control centers, and cosmeceutical manufacturers, to provide promotional and educational information to both patients and physicians. In yet another example, the prescription subsystem uses a combination of patient and prescribed drug information to adjudicate insurance claims and screen for potentially harmful drug interactions. In another example of data sharing, the prescription subsystem shares inventory information with the patient care items subsystem and the OTC medication and cosmeseutical subsystem so as to track the dispensing of nearly all the physician's remaining retail items. These examples of information sharing between subsystems are for purposes of illustration and are by no means exhaustive. In addition, as will be apparent to one of ordinary skill in the art, though the invention is described with reference to specific examples, the hardware, software and location functions can be easily modified.

The present system can utilize one or more computers. As used herein computer, including a user computer, cabinet controllers and the computers comprising servers, can be any microprocessor or processor controlled device that permits access to the Internet, including terminal devices, such as personal computers, workstations, servers, clients, mini computers, main-frame computers, laptop computers, a network of individual computers, mobile computers, palm-top computers, hand-held computers, set top boxes for a TV, interactive televisions, interactive kiosks, personal digital assistants, interactive wireless communications devices, mobile browsers, or a combination thereof. The computers can further possess input devices such as a keyboard, mouse, touchpad, joystick, pen-input-pad, output devices such as a computer screen and a speaker, fingerprint readers, touchscreens, label printers, and the like.

These computers may be uni-processor or multi-processor machines. Additionally, these computers include an addressable storage medium or computer accessible medium, such as random access memory (RAM), an electronically erasable programmable readonly memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content such as, by way of example, programs and data. The computers can be equipped with a network communication device such as a network interface card, a modem, or other network connection device suitable for connecting to a networked communication medium.

Furthermore, the computers execute an appropriate operating system such as Linux, Unix, Microsoft® Windows®, Apple® MacOS®, or IBM® OS/2®. As is conventional, the appropriate operating system includes a communications protocol implementation which handles all incoming and outgoing message traffic passed over the Internet. While the operating system may differ depending on the type of computer, the operating system can continue to provide the appropriate communications protocols necessary to establish communication links with the Internet.

The computers may advantageously contain program logic, or other substrate configuration representing data and instructions, which cause the computer to operate in a specific and predefined manner as described herein. The program logic advantageously can be implemented as one or more modules. The modules may advantageously be configured to reside on the addressable storage medium and configured to execute on one or more processors. The modules include, but are not limited to, software or hardware components which perform certain tasks. Thus, a module may include, by way of example, components, such as, software components, object-oriented software components, class components and task components, processes, functions, attributes, procedures, subroutines, segments of program code, drivers, firmware, microcode, circuitry, data, databases, data structures, tables, arrays, and variables.

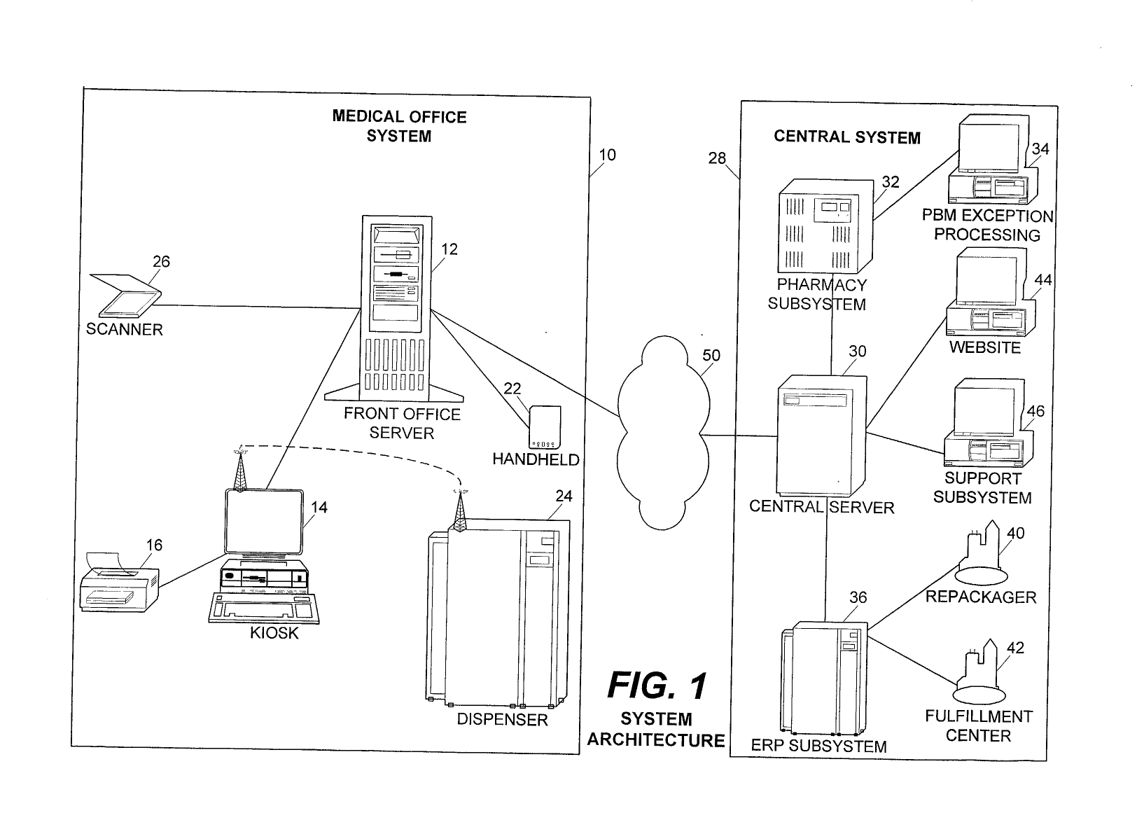

FIG. 1 provides an example of suitable system architecture. A medical office system 10 can include various components, including a front office server 12, a kiosk 14, a printer 16, a scanning device 20, a handheld device, a dispenser or product cabinet 24, and a scanner 26. The printer 16 can be a label printer, for example. Although FIG. 1 depicts a limited number of components, the present invention also contemplates the use of other appropriate devices and components that are well known in the art. The components can reside together as part of a single piece of hardware or they can include various individual hardware pieces. For example, the front office server 12 and the kiosk 14 can reside separately or they can reside together as part of a single computer, or the like. In another example, the dispenser 24, the kiosk 14, and the front office server 12 can be a part of one integrated piece of hardware. The various architecture configurations can be used according to the circumstances in the individual medical office. One of skill in the art can easily determine the appropriate system architecture based upon the needs, limitations, and demands of particular medical office.

The medical office system components can communicate by methods well known in the art. Communication can be by wireless communication, as is exemplified between the kiosk 14 and the dispenser 24. The components can communicate through network connections, such as for example, a local area network, an intranet, and the like. Alternatively, the front office server 12 further communicates with other medical office system components or kiosks 14 through a local network connection. For example, the physician office network can include the front office server 12, a computer 14 that serves as a point-of-sale subsystem and a number of other computers 14, 22 all of which can accept patient and prescription information. Similarly, most subsystems described herein can be implemented on various computers, kiosks, or servers. One skilled in the art will immediately recognize that a front office server 12 can act as a point-of-sale subsystem, a data entry subsystem that accepts both patient and prescription information or even perform all of the combined functions of the physician office computer network.

One or more networked computers or kiosks 14 can be capable of communicating with one or more or the dispenser units 24 in the physician office. Communication may be facilitated through a local area network (LAN), the Internet, radio frequency transmissions, or similar means. Dispensing of medication can either occur automatically when a dispense command is received by the appropriate dispenser unit from one of the networked computers or manually when an authorized system user accesses a dispenser unit to physically remove the appropriate medication.

FIG. 1 also includes a central system 28. The central system 28 includes a central server 30, a pharmacy subsystem 32, a PBM Exception processing subsystem 34, an ERP subsystem 36, a repackager 40, a fulfillment center 42, a website 44, and a support subsystem 46. These various components can communicate according to methods well known in the art, including by Internet, wireless, and like communications methods.

The communication between the medical office system 10 and the central system 28 is provided through a network 50, such as a secure Internet connection. The Internet connection also can link the central server 30 to each of the above servers and systems and subsystems, including the medical office system 10, the pharmacy adjudication subsystem, the ERP subsystem, and the like. Preferably, a large number of medical offices, each having its own front office server 12, can communicate with the central server 30 via the Internet. Alternatively, the medical office system can communicate directly with parties, such as a pharmacy system (and the pharmacy adjudication subsystem), without communicating through the central system.

Further, communication between systems, subsystems, and components that utilize hardware components is provided via a communication system, such as the Internet. Communication between software subsystems is provided by the necessary programming instructions. One skilled in the art will immediately recognize that the instructions encoding the functionality of a networked subsystem may reside at any point on the network.

Another component of the system is the one or more units capable of dispensing packages of a variety of shapes and sizes. The units may be referred to as dispensers, dispenser units, product cabinets, and other like designations. Referring to FIG. 1, dispenser 24 can generally exemplify the relationship of the dispenser units described herein with the system architecture. All dispenser units can include a system by which access can be regulated, such as by a lock. Locks can be mechanical, electronic or any other system that can be used to regulate dispenser access. The system can be configured for controlled dispensing of products. The system can be configured to dispense, release or grant access to products within the dispensers. Such dispensing can be in response to control signals sent to the dispensers by the various subsystems or components of the system. It should be noted that discussion herein may indicate that dispensers can be opened or unlocked by the various systems or subsystems. Such opening or unlocking can be accomplished by sending a control signal to a dispenser or dispenser system, or by any other equivalent method known in the art. Such unlocking or opening may be accomplished directly or indirectly by the subsystems. The dispensers can be coupled to the various components and subsystems. The various subsystems and components can send a control signal to a dispenser for the release, dispensing or granting of access to a product.

The dispensers can include dispensing bins, wheels, chutes, and the like within the dispenser. Thus, dispensers can include different sub-dispensing components that can be accessed by a user after the main door to the dispensing unit is opened by the system. The interior or sub-dispensing units, including bins and chutes, can include “smart” technology, which is described herein. Smart technology can include sense the take technology that also is described more fully herein.

Certain dispenser units can include one or more refrigerated compartments. Whether a dispenser unit includes refrigeration depends on the types of drugs commonly stored inside. For example, an OTC medication dispenser may not typically require refrigeration, whereas a dispenser containing patient care items such as vaccines almost certainly requires refrigeration.

Some dispensers can integrate computer functionality into the unit design. Others are subject to the control of an attached computer or a remote computer via a network connection. Still other dispenser units may not be subject to computer control but rather can be operated only manually. Each of these dispenser configurations can be utilized in alternative embodiments of the present system.

The dispenser unit can take the form of an automatic unit similar to a vending machine. Exemplary dispenser units are described, for example, in U.S. Pat. Nos. 4,847,764, 4,695,954 and 6,068,156 which are incorporated herein by reference.

Alternatively, a dispenser unit can be a cabinet which houses a number of compartments with each compartment containing a specific type of medication. The dispenser can be a cabinet-type dispenser unit which is housed in existing physician office cabinetry. A dispenser unit 24 can contain gravity-fed bottle storage/dispensing boxes, which can be arranged according to the physician office needs or even completely removed. It is apparent to one skilled in the art that such dispenser units can contain various types of removable boxes, bins, racks, trays and other like compartments for holding medications.

Also, the dispenser can include the construction of a single cabinet-type dispenser unit which can be built in a variety of shapes and sizes. The dispenser can be designed to be used either alone or in combination with other cabinet-type units. Combination use can be achieved by placing cabinets side-by-side, on top of each other, and other multiple cabinet configurations. The dispenser can be a computer-controlled dispenser cabinet assembly made of multiple single cabinet-type dispenser units. The dispenser cabinet assembly can be attached to and can be controlled by a kiosk, such as kiosk 14 of FIG. 1. Tall cabinet-type units can house gravity-fed bottle storage boxes, whereas shorter cabinet-type units can house shallow storage bins. The dispenser can be a single cabinet-type dispenser unit that is capable of housing a mini-refrigerator. It will be apparent to one skilled in the art that size, number and type of internal medication dispensers housed by each cabinet-type unit might only be limited by the size of each unit.

Each component of the present system can meet UL requirements, pass OSHA regulations and be physically placed to meet local fire codes. In the event that such regulations or other space constraints prohibit placement of subsystems and components, such as, kiosks and access points in close physical proximity to the front office server, each of the system components can be networked with the front office server so that information flow is fast and does not require manual intervention. Preferably, a network utilized with this system supports fast and secure data transfer. Some physician offices have networks that can be utilized for this purpose. For those offices not equipped with an appropriate network, installation may be required. Such installation is routine in the art.

User security is another component of this system. Due to the clinical nature of this system, there are numerous areas where system access can be strictly monitored. Because this system contains and transmits patient specific data in accordance with the requirements set out in the Health Insurance Portability and Accountability Act of 1996 (HIPAA), users are granted only certain access rights and privileges. In addition, since the present system can be accessed by a wide range of users and both physically and through the Internet, users are permitted different levels of access depending on their group status and point of entry into the system. The following user groups require different levels of access: physician, nurse, medical assistant, clerk, office manager, pharmaceutical representative, pharmaceutical sales manager, regulatory agencies, health care system administrator, technical support staff, system proprietor, and patients. Specific group and individual user templates are defined that determines a user's access rights. This mode of user security enables the system to provide a high level of security without burdening the system manager with data input for system installation.

Front Office Server

The front office server 12 can be a database and web server machine, for example. The front office server can be located in a physician or medical office. It can serve data to the user interface kiosks 14 described herein. It can be also the point of communication between the physician's office and the backend or central systems 28 described herein. The front office server can also interface with an office's practice management system, script input devices (e.g. handheld electronic prescribing pads), and other sources of data. The front office server can have a database that contains the inventory of the office, the users, ordering information, and transactions. The database can also include the patient information, marketing content, drug interaction information, as well as any other data as described herein. The data stored on the front office server can be utilized to generate many of the reports, marketing information, and patient benefit profiles, such as prescribe worksheets that are generated within the physician's office. The hardware comprising the front office server can serve multiple roles depending on the size and topology of the particular office.

The server can double as a system user interface kiosk. The server, the kiosk, and the dispenser can be part of one hardware device. The server can include a radio frequency transceiver for controlling medication dispensers or for receiving and/or transmitting data to and from other system components.

The front office server database can contain all of the information necessary to perform the required tasks. This allows the system to fully operate when connectivity to the central server is not available.

Central Server

The central server can be a central data warehouse, application, web server and the like. The central server can act as a focal point of the present system. The central server can be located in the home office data center facility. The central server can include a data warehouse or database, which can be an aggregation of all of the front office servers in the entire network. The central server can include a data warehouse, which can contain items, such as for example, the demographics, configurations, and users of the client physician offices; the inventories of all the offices; all utilization data from the offices; data content for delivery to specific offices or individual physicians; aggregated and processed data of interest to pharmaceutical companies; drug interaction databases; company product and service lists; data related to company product and service promotions; and physician education and reference material, such as, results of recent clinical studies and an online PDR; and the like.

The central server's application server can communicate with the front office servers at the client physician offices or with the subsystems implemented on the medical office system 10. Advantageously, the communication can occur in a secure manner over the Internet using established protocols. The server can receive inventory and transaction information that is stored in the data warehouse. Order requests from the physician office can be processed and forwarded, for example, to the fulfillment center via the ERP.

The central server also can interface with pharmaceutical companies, including pharmaceutical sales force representatives. A representative can be informed of the status specific physician offices, for example, by an email notification, an interactive website, integration with sales force automation software and other similar communication methods. An authorized system user, such as a pharmaceutical representative, can also. obtain reports, such as those regarding, relationships between prescribing physicians and samples, physicians and medications, medications and diagnosis, patient type and prescription, and the like.

The central server also can be responsible for the delivery of various informational content to the physician offices. Marketing information can be delivered to physician offices. Further, clinical information, and technical support, and the like can be delivered to physician office. For example, items such as personalized electronic coupons, drug information, clinical trial participation, targeted advertising, and the like are sent to the appropriate offices and physicians. Again, the term “physician” as used herein is meant to broadly include health care professionals in various disciplines including where applicable traditional medicine, dentistry, chiropractic care, and the like. Physician office should also be construed broadly to encompass a patient's place-of-care.

The central server also can perform system monitoring and maintenance. Home office personnel can determine the configuration and status of the installed equipment at any physician office and communicate with physician office personnel. System upgrades can be directed and controlled by the central server. Software upgrades can be pushed from the central server to the front office servers at the physician offices, eliminating the need for an application specialist to make a trip to the office.

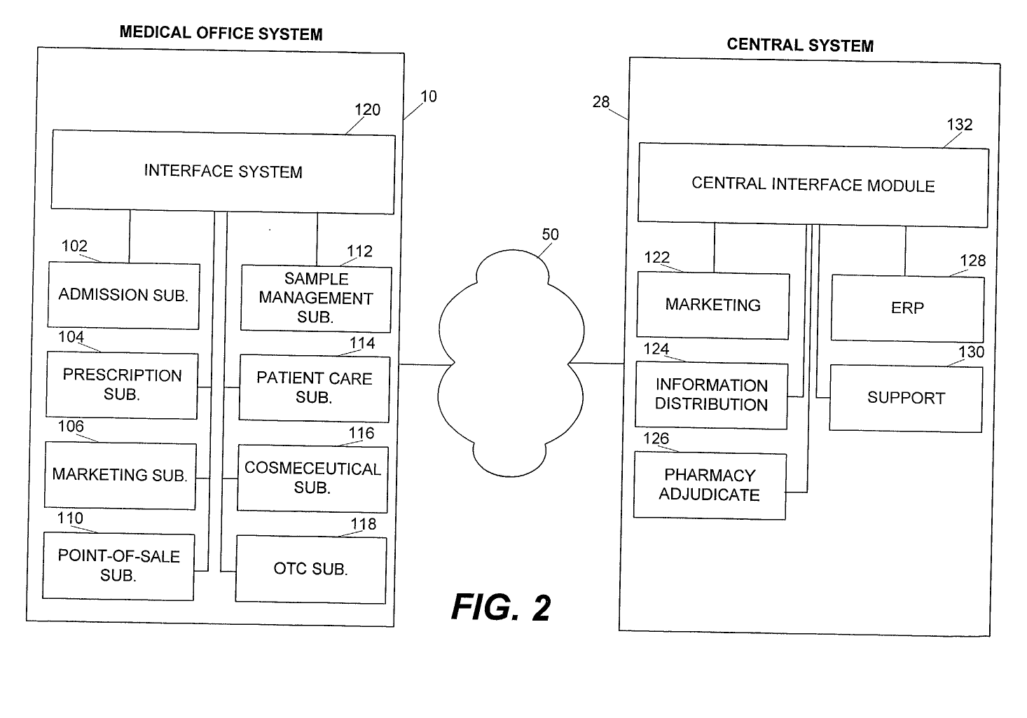

FIG. 2 is a functional block diagram of the medical office system 10 and the central system 28. Referring to FIG. 2, the medical office system 10 can include an admission subsystem 102, a prescription subsystem 104, a marketing subsystem 106, a point-of-sale (POS) subsystem 110, a sample management subsystem 112, a patient care subsystem 114, a cosmeceutical subsystem 116, and an over-the-counter (OTC) subsystem. Each of the subsystems is described in more detail herein.

It should be noted that additional and duplicative subsystems can be included. For example, the medical office system can also include a separate inventory management subsystem. Alternatively, inventory management can be administered by the one or more of the listed subsystems. Further, multiple marketing subsystems can function on the system. Also, subsystems such as the cosmeceutical and OTC can easily be included in one subsystem.

The interface system 120 directs and facilitates communication to and from the subsystems and also between the different subsystems. As discussed herein, information can be gathered by one subsystem and then distributed to as needed to other subsystems. For example, as will be discussed more fully herein, the admission subsystem 102 can gather patient information, which may then be utilized by the other subsystems. For example, the information can be used by the prescription subsystem 104 to aid in the selection of an appropriate prescription. When a prescription is input into the system, the information can be communicated to and utilized by the marketing subsystem 106, for example, to generate e-coupons and the like.

FIG. 2 also includes a central system 12. The central system 12 includes a central marketing subsystem 122, an information distribution subsystem 124, a pharmacy adjudication subsystem 126, an enterprise resource planning subsystem (ERP) 128, and a support subsystem 130. A central interface module 132 facilitates and directs communication to and from the subsystems and interaction of the subsystems with other components of the system, including between the different subsystems on the central system 28.

Information can be communicated between the medical office system 10 and the central system 28 by means well known in the art, including via an internet 50, wireless communication, and the like. For example, as discussed more fully below, prescription information from the prescription subsystem 104 can be communicated to the pharmacy adjudication subsystem 126 for adjudication and a DUR analysis. One of skill in the art will recognize that the FIG. 2 illustrates specific subsystems that can operate on specific systems, also contemplated variation and duplication of subsystems on the different systems. For example, both systems can have marketing subsystems. Also, for example, the medical office system 10 can include a support subsystem. As noted above, additional subsystems are contemplated and apparent to one of skill in the art.

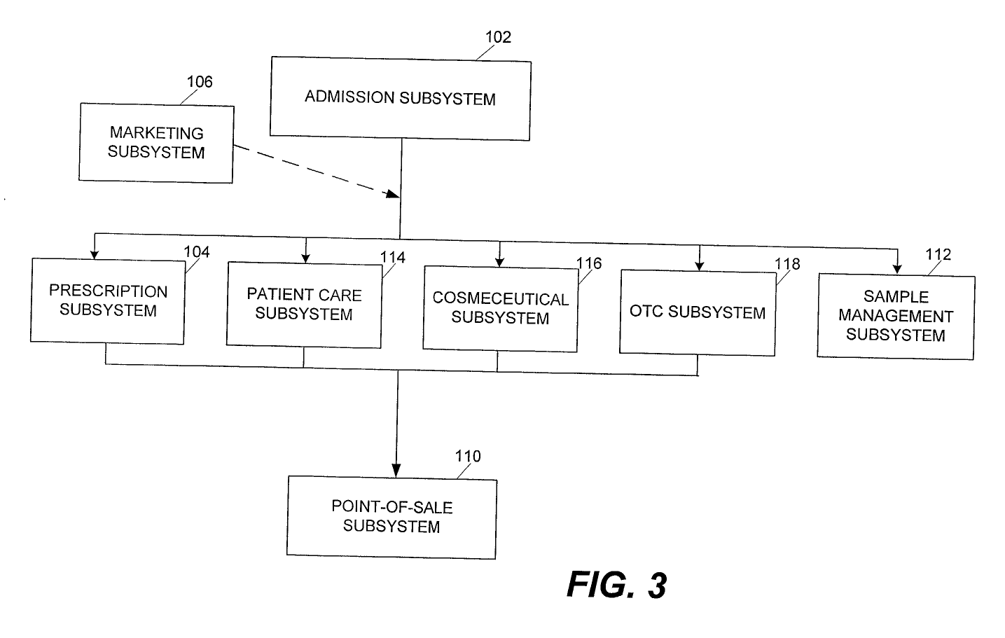

FIG. 3 exemplifies the interaction between subsystems on the medical office system 10, and the flow of information during a visit to a medical office. Data obtained by the admission subsystem 102 can be utilized by any of the subsystems, including the prescription subsystem 104, the patient care subsystem 114, the cosmeceutical subsystem 116, the OTC subsystem 118, and the sample management subsystem 112. Further, the marketing subsystem 106 can distribute data to the various subsystems. The prescription subsystem 104, the patient care subsystem 114, the cosmeceutical subsystem 116, and the OTC subsystem 118 can interact with the POS subsystem 110 when payment is required. Although not necessarily illustrated, it should be noted that the prescription subsystem 104, the patient care subsystem 114, the cosmeceutical subsystem 116, the OTC subsystem 118, and the sample management subsystem 112 can communicate information with each other. For example, when a particular prescription is dispensed by the prescription subsystem 104, based upon the particular medication, the cosmeceutical subsystem 116, the OTC subsystem 118, and the sample management subsystem 112, alone or in conjunction with the marketing subsystem 106 can recommend or suggest other items that might be beneficial to a patient with a condition necessitating the prescribed medication. The various subsystems are described in more detail below.

Admission Subsystem

The system described herein fully incorporates patient admission, and thus, it becomes an integral part of streamlining the front office workflow. A patient visit to the physician office usually begins with check-in and collection of the visit co-pay at the front desk by the clerk, all prior to the patient examination. Current admissions, scheduling, billing and other like procedures are typically managed through a practice management system (PMS).

To provide increased utility to the physician office staff, there are options that allow this system to either integrate or coexist with the physician office PMS. One option, includes a complete interface between the admission subsystem and the office PMS. Such an interface allows a clerk to easily transfer patient data stored by the PMS to the admission subsystem as well as to enter new patient information into both the PMS and the admission subsystem at the same time. A second option provides for a stand-alone admission subsystem that physically resides next to the physicians existing PMS. A third option provides for a standalone subsystem that resides on the physician's exiting PMS as an icon that accesses either the admission subsystem or the front office server. Unlike the first option, the second and third options require that the clerk to enter patient information into two systems or transfer the information from one system to the other.

The admission subsystem streamlines the workflow of the front office staff by providing several essential features. The basic function of the admission subsystem is to receive or collect, process and maintain, and display patient information. However, to expand its functionality, this subsystem incorporates additional features, such as, patient searching capabilities, a data retrieval module, new patient information templates and patient information editors. Also, the admission subsystem accepts any information required for pharmacy benefits managers (PBMs).

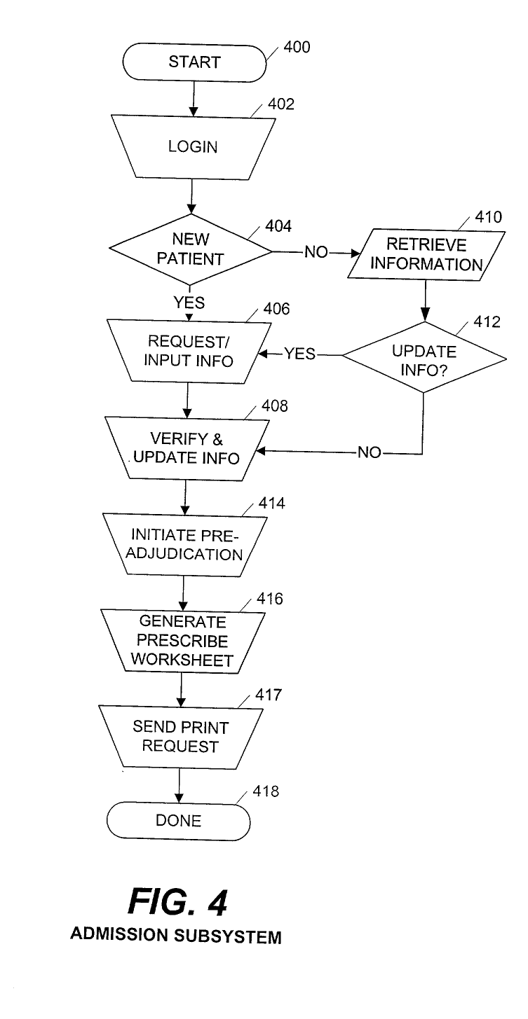

FIG. 4 illustrates patient admission and data gathering. The subsystem requires login 402 in order to maintain system compliance, privacy and integrity. It should be noted that where necessary, access to any of the systems and subsystems can be limited to authorized users after proper login. The subsystem queries whether a new patient 404 is being entered.

If a preexisting patient is being admitted, then the subsystem retrieves the existing patient information 410. The subsystem then queries whether the existing patient's information needs to be updated 412. If it needs to be updated, then the subsystem prompts for the relevant new patient information 406. If the existing information is accurate, then it is verified 408 and a pre-adjudication is initiated 414.

If at 404 a new patient is being admitted, then the subsystem prompts for the relevant new patient information 406. After the information is received, it is verified and/or updated 408.

Following the update and verification process 408, the admission subsystem utilizes the current information to initiate a pre-adjudication check 414 for the patient. To obtain and successfully execute a pre-adjudication check, the subsystem can route the patient information to the pharmacy adjudication subsystem on the central system. Alternatively, the medical office system can be configured to include all of the necessary information to handle and perform the pre-adjudication check. For example admission subsystem (or other subsystems, such as the prescription) can perform and execute the check. In either case, a determination is made of whether the insurance information given by the patient is accurate, which drugs currently stocked in the physician's inventory are covered by the patient's insurance plan, and a clinical interaction check (DUR) can also be performed.

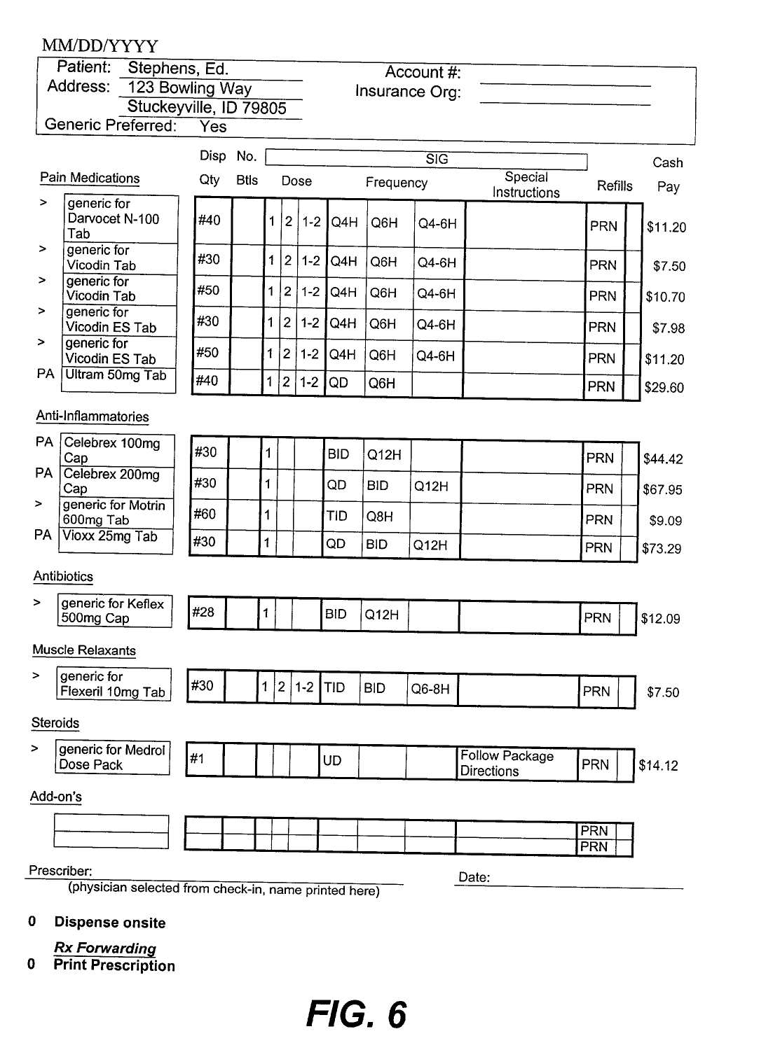

As a result of the pre-adjudication a prescribe worksheet is generated 416 and the subsystem transmits a print request 417. The prescribe worksheet represents one type of patient specific drug benefit profile. Patient specific drug benefit profile can be generated to include and reflect patient specific information such as the patient's chief complaint, benefit design, reimbursement status (cash and co-pay), current inventory status, and other like information. This patient specific benefit profile can be designed to dynamically apply the individual physician's high volume prescribing habits against a specific patient's drug plan. This information can include relevant information regarding the status of particular drugs within the medical office system (e.g. par levels and virtual inventory (e.g. another MD's inventory)), as well as benefit implications for medications typically prescribed, but not currently in inventory. The profile can be displayed or made available as printed form as exemplified in FIG. 6, for example. However, the prescribe worksheet can also be replaced by a hand-held computing device, a data terminal, a computer, and other like devices and articles. It can also include bidirectional sharing of this information to third party systems and/or devices.

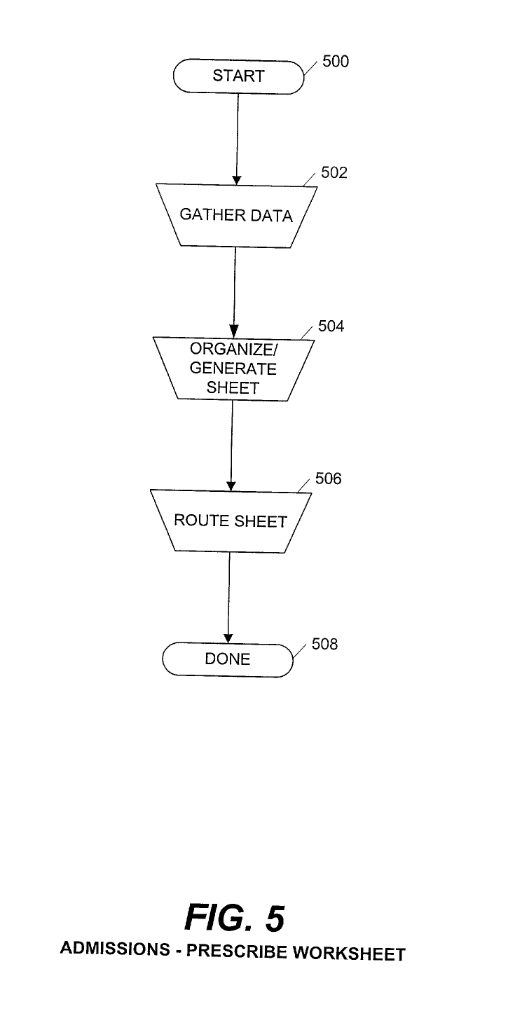

The patient specific drug benefit profile, such as the prescribe worksheet, can be utilized during the prescription process by the prescription subsystem. FIG. 5 illustrates the generation of a prescribe worksheet, for example, by the Admission subsystem. First the system gathers and retrieves the data from the necessary sources at 502. Then the subsystem organizes the information and generates the worksheet 504. The sheet is routed 506 to the appropriate location and printed (or displayed) for use in the prescription subsystem.

The system disclosed herein achieves integration of data management into the drug dispensing process by providing a communication network that allows each of its subsystems to send and receive information. As discussed herein, the admission subsystem can be responsible for collecting patient information and distributing it or making it available to other appropriate subsystems. For example, patient information obtained from the admission subsystem is used by the sample management subsystem, which tracks a physician's dispensing of sample medications by patient and provides compiled drug usage and drug inventory reports to pharmaceutical representatives as well as regulatory reports to the physician. In another example, patient information from the admission subsystem can be used by the marketing subsystem to allow entities, such as, pharmaceutical companies, disease control centers, and cosmeceutical manufacturers, to provide promotional and educational information to both patients and physicians.

Prescription Subsystem

The prescription subsystem enables the physician to make informed decisions regarding the dispensing of medications at the point of care. This subsystem utilizes the collected data on the patient specific drug benefit profile. Again, an example of such a profile is the PreScribe Worksheet, exemplified in FIG. 6. The PreScribe Worksheet can contain information such as names and quantities of medications that are in current inventory, medications that are listed in the patient's PBM plan, medications that potentially have an adverse reaction either through an allergy or a food/drug interaction, medications that best meet other physician selected dispensing requirements, tiering within the patient's plan, and other like information. Based upon the data in the PreScribe Worksheet, the physician can determine which drug(s) best meet his/her dispensing criteria. In the event that it is necessary, the PreScribe Worksheet also can act as the information tool that is to route or print a script to be filled outside of the office.

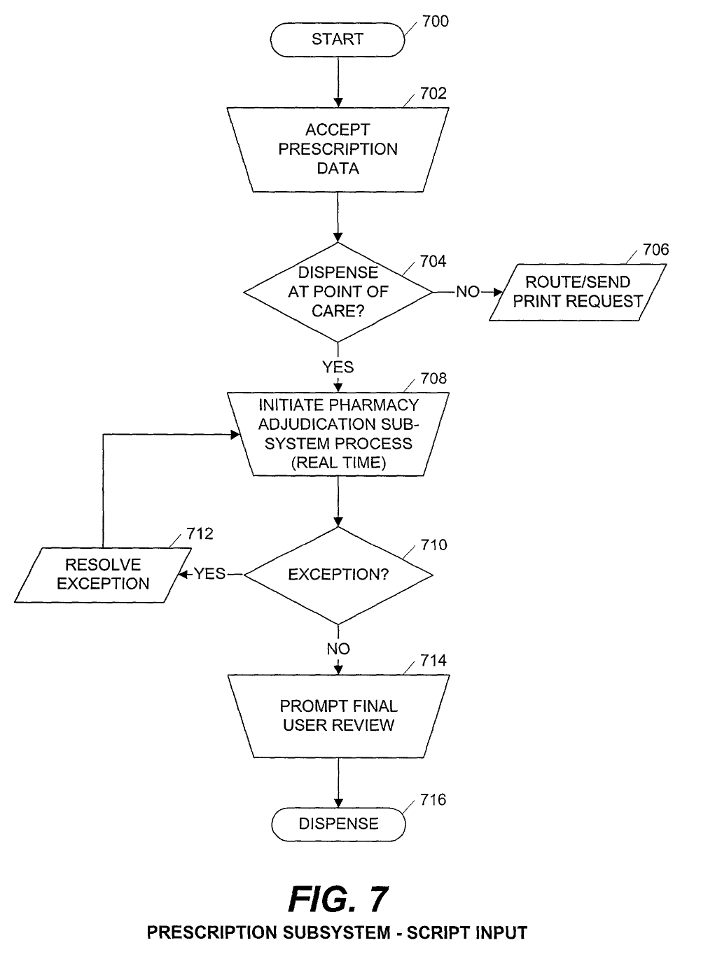

When the physician and patient agree on a medication, the physician enters the prescription into the prescription subsystem. FIG. 7 illustrates the prescription input process. The subsystem accepts prescription data 702 as entered by the physician. The prescription subsystem can accept data in a variety of formats so that the prescription information can be easily entered. For example, data may be entered into this subsystem from any networked office kiosk, from a hand held electronic prescribing unit, from a handheld scanner or prescription scanner, or from any other like method or device. At 704 if the prescription is to be dispensed in the medical office or point-of-care, then the prescription subsystem transmits the relevant drug and patient information via the front office server to the pharmacy adjudication subsystem for real time adjudication 708. If the medication is not available or if the patient declines to receive it at the medical office, then at block 706, the prescription subsystem routes the prescription information to a pharmacy of the patient's choosing. Transmission of prescription information to an offsite pharmacy may be done by e-mail, fax, patient delivery of a printed hardcopy of the prescription, or any other comparable delivery method.

Real time adjudication 708 occurs through Internet-mediated communication between the prescription subsystem and one of a number of PBM switches. The PBM switches are members of the pharmacy adjudication subsystem that have contracted with the PBM to adjudicate claims. At block 710, unless an exception is generated, the pharmacy adjudication subsystem can complete adjudication and return the results to the prescription subsystem within ten seconds, whereupon the subsystem can prompt for final review 714 prior to dispensing the medication 716.

If an exception is generated 710, the pharmacy adjudication subsystem routes the results of the exception to the appropriate subsystem for resolution 712. After attempting to resolve the exception, a pharmacy adjudication check is again initiated 708. If there are still exceptions, then the resolution again occurs 712. If no exceptions occur then the subsystem prompts for final review 714 and the medication is dispensed 716. In any event, the results of each adjudication attempt are stored both on the appropriate physician office front office server and the central server.

The system is capable of resolving all types of adjudication exceptions in real time. Initially, exception handling is achieved by the pharmacy adjudication subsystem, which is able to route or handle all types of adjudication exceptions that the physician office will encounter. This subsystem maintains adjudication flow through a set of rules for routing exceptions to the appropriate location, whether it be the physician office, specialized system personnel, or an offsite pharmacist. For example, an exception resulting from an error made by the physician can be routed back to the prescription subsystem. The physician, who is alerted to the exception by the system, can then correct and resubmit the information. In the event that the error which causes the exception can be resolved without contacting the physician, the exception can be routed to specialized system personnel who can resolve issue. For example, a physician writes a script for a 60 day supply of medication; however, the insurance company only allows 30 day supplies. The system's pharmacy technician can resolve the issue by changing the prescription to allow a 30 day supply plus one refill. In the event that neither system personnel nor the physician can resolve the exception, the system can electronically route the prescription to a pharmacy of the patient's choosing. The pharmacy adjudication subsystem also can capture any variance between the contract pricing and the adjudicated pricing.

While the adjudication process occurs, the patient information and drug information are automatically reviewed to determine any known patient drug allergies and conflicts or interactions with current drug therapy that would prevent the newly prescribed medication from being safely and effectively administered. Such automatic screening can be performed by either the central server, the pharmacy adjudication subsystem, or the pharmacy subsystem, for example, while performing a drug utilization review (DUR). In any case, the online drug interaction database can allow the user to set the sensitivity of the system for determining drug interactions. Thus, an authorized user can select a custom sensitivity level based on specific criteria. After the screen is completed, the results are recorded and automatically returned to the physician or other appropriate staff member before dispensing of the drug occurs. This automated process can either substitute for physician's interaction review, thereby saving the physician time, or act as a means to verify the physician's findings.

After reviewing the results of the adjudication and the DUR, the physician verifies that the appropriate medication has been prescribed and authorizes dispensing of the medication to the patient. Typically, the physician counsels the patient regarding the proper use of the medication at the time the prescription is written, and any medical office user, legally authorized to do so, then performs most of the tasks associated with dispensing prescription medications.

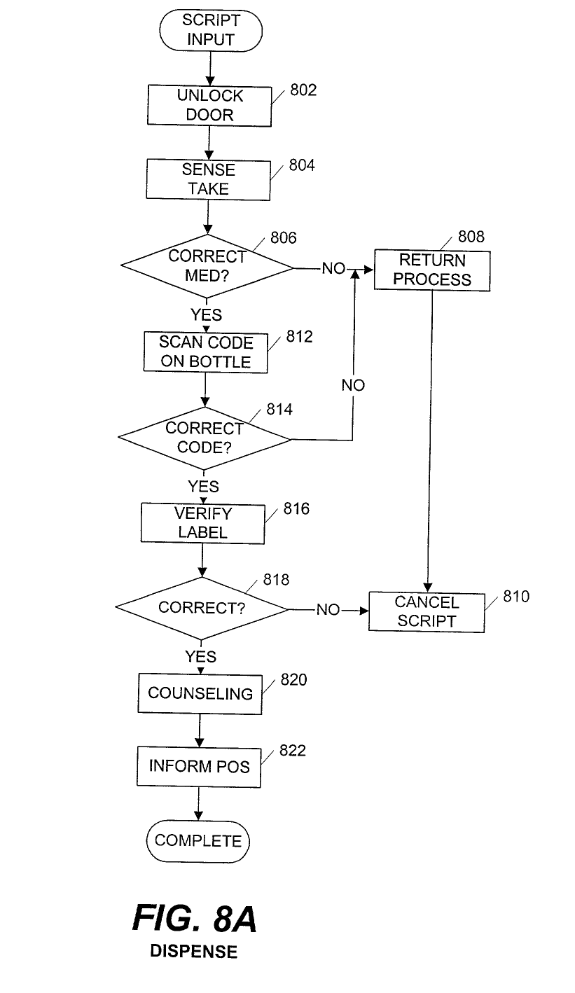

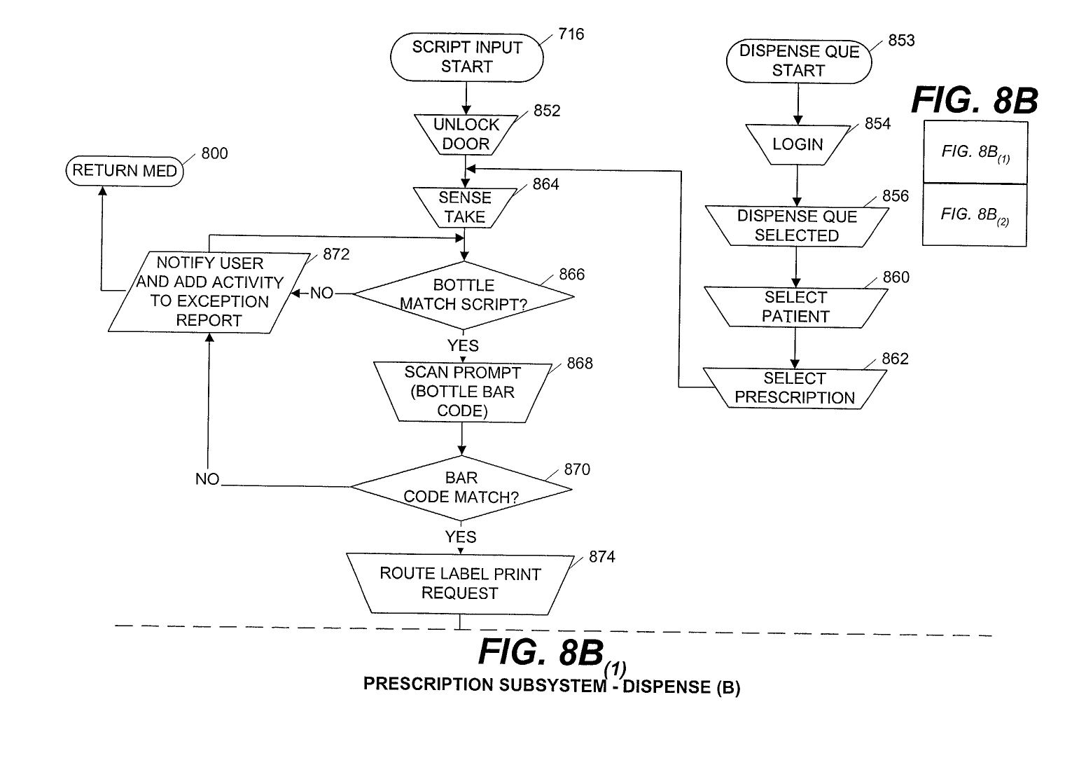

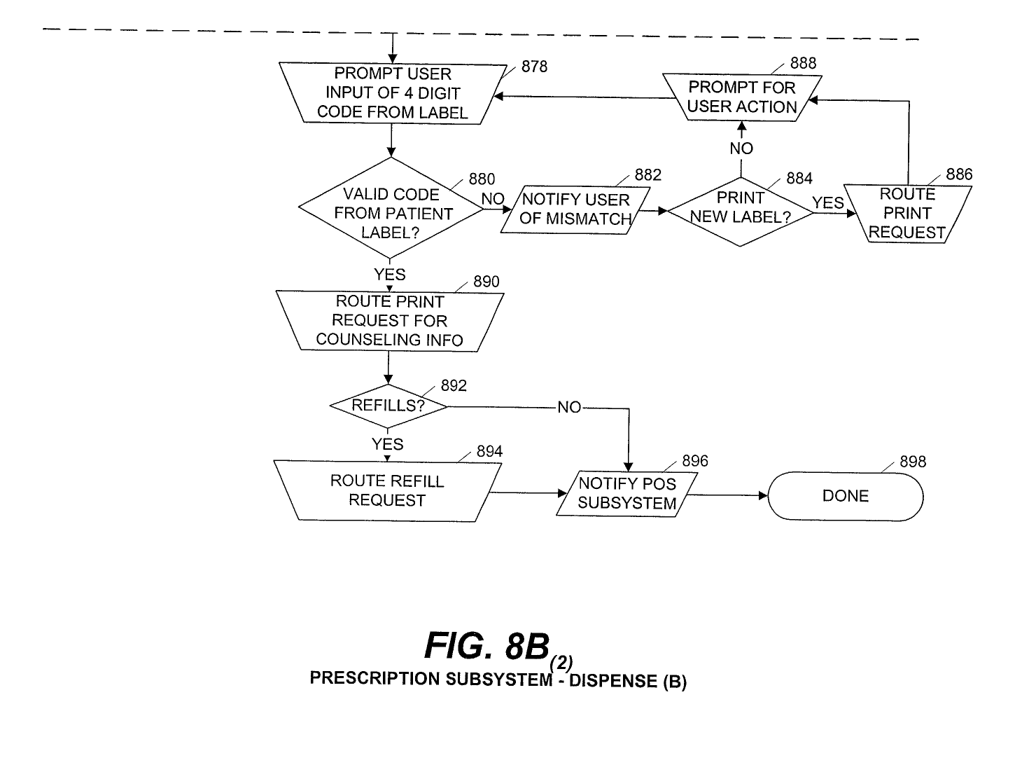

FIG. 8A and FIG. 8B illustrate medication dispensing by the prescription subsystem. Typically, the dispensing tasks can be performed by the physician, an RN/MA or other authorized user. Referring to FIG. 8A, after a prescription is received by the subsystem, for example as illustrated in FIG. 7 at block 716, the subsystem unlocks a dispenser door 802. For example, this can be done in response to some sort of control signal sent by the subsystem. The subsystem then dispenses, releases or grants access to the prescription. The subsystem can utilize “sense the take” technology to detect when a medication is removed 804 from the dispenser. After a medication is removed from the dispenser and the take is sensed, the subsystem can automatically update the inventory for the medication. Alternatively, dispensing of the medication can be sensed by other methods that are known in the art. Although “sense the take” technology is depicted in FIG. 8A, taking of the dispensed medication can be recorded or entered manually by the user or by various other methods known in the art.

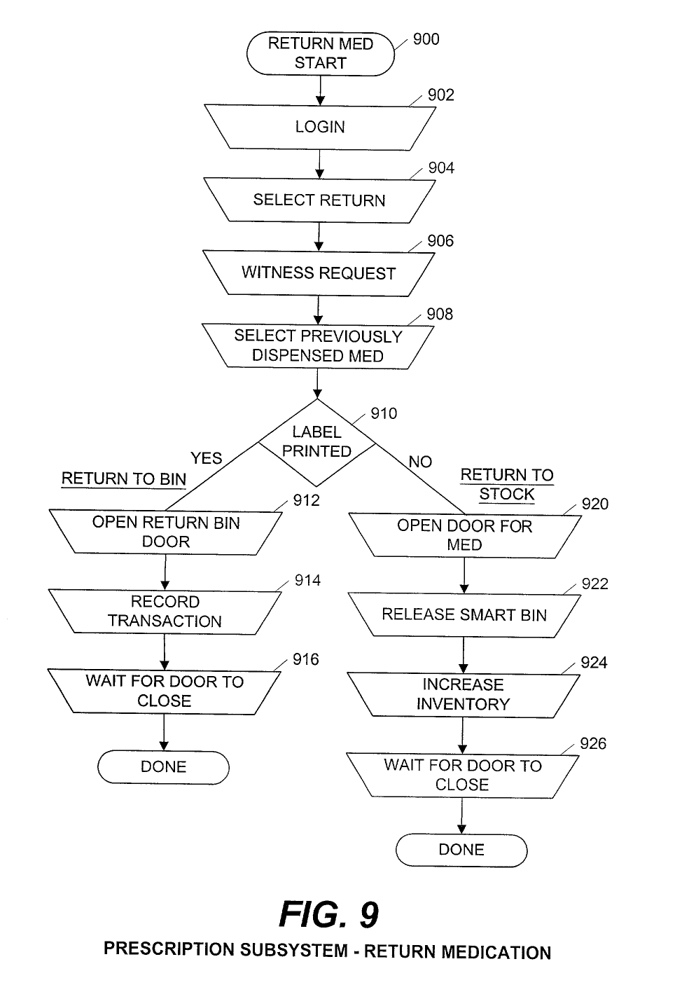

If an incorrect medication has been taken 806, the subsystem initiates a medication return process 808, for example, similar to that illustrated in FIG. 9 and the prescription is cancelled 810. If the subsystem determines that the correct medication is taken 806, the user then is prompted to scan the bar code on the medication container or bottle 812. If the scanned code does not match the code in the subsystem 814, the subsystem initiates a medication return 808 and cancels the dispense transaction 810. If the scanned code matches the code in the subsystem 814, then the user is prompted to verify the label on bottle visually 816. If the label is incorrect 818, the subsystem cancels the prescription 810. If the label is correct 818, then the subsystem requires acknowledgement of patient counseling by the physician or otherwise authorized person 820. Finally, the prescription information is sent to the POS subsystem 822.

FIG. 8B illustrates another alternative medication dispensing task flow, which provides the RN/MA or physician an alternative means for verifying that the correct bottle of medication has been dispensed. The dispense process depicted in FIG. 8B can be initiated in either of two different ways. It should be noted that other initiation schemes are contemplated although not specifically depicted in FIG. 8B. The dispensing process can be initiated directly from the prescription input process 716 as depicted in FIG. 7, for example. After the prescription is properly input, the subsystem sends a control signal to dispense the product. This causes the dispenser door to be unlocked and the medication is made available for retrieval by the physician, RN or MA. The subsystem can sense when the medication is taken 864.

Alternatively, a dispense queue can be initiated 853. After login 854 and selection of the dispense queue process 856, the system displays selection list and prompts for selection of the appropriate patient 610 with a pending prescription in the system and that is ready for dispensing. After the user selects the appropriate patient the subsystem displays a list of pending prescriptions for the patient and the user can then select the desired prescription for dispensing 862.

Under either initiation scenario the subsystem senses when the dispensed medication is removed from the dispensing unit 864. This can be done using “sense the take” technology. Sense the take technology senses when the dispensed medication is actually removed from the dispensing apparatus or device. Existing dispensing technology has generally sensed when a medication is dispensed and made available for retrieval. Such systems do not indicate if and when a medication is removed, if ever. The system has no way of knowing if and when the medication is actually taken, which can lead to mix up of dispensed medications. Sense the take technology allows the subsystem to ensure that a medication is removed from the correct dispenser.

The subsystem further requires verification that the dispensed bottle matches the intended prescription 866. If the bottle does not contain the intended medication, then the user is notified and an exception is noted in the subsystem 872. The incorrect bottle is then returned to the dispenser, for example, as discussed below referring to FIG. 9. Where the bottle matches the prescribed medication 866, the user then is prompted to scan the bottle bar code 868. If the scanned bar code does not match the code in the subsystem, the user is notified, an exception is noted in the subsystem 872, and the medication is returned as in FIG. 9. If the scan code matches the code for the prescription in the subsystem, then the subsystem routes a label print request 874 to the appropriate printing device.

The subsystem next prompts for a scan of the printed label bar code 876 and for user input of the 4 digit code from the label 878. If the code for the scanned medication is invalid 880, the user is notified of the mismatch 882. If desired the system routes and prints a new label 884, 886, prompts for user action 888 and returns to the label barcode scan prompt 876. If no new label is desired 884, the subsystem prompts for user action 888 and repeats the label bar code scan prompt 876. If the code is valid 880 for the scanned medication, the subsystem routes a print request for patient counseling information 890. If refills are desired 892 a request is routed 894 by any of a number of methods, including fax, mail order, e-mail, hard copy, and the like. The subsystem then notifies the POS subsystem 896 of the dispensed medication and the process is complete. If refills are not wanted 892, the system can simply notify the POS subsystem 896 of the dispensed medication and the process is complete.

The prescription subsystem also allows the physician to pre-authorize refills for any prescribed medications. At the patient's request, the prescription subsystem will automatically place mail order refill requests for the patient so that the patient can receive his medication on time and without having to leave his home and the subsystem can route refill requests to a local pharmacy of the patient's choice. This can be done by conventional mail, e-mail, fax, and other like methods.

In the event that a prescribed medication is not available from the physician office dispenser or that a patient desires to have the prescription filled elsewhere, the prescription subsystem routes the prescription information to a pharmacy of the patient's choosing. Transmission of prescription information to an offsite pharmacy may be done by E-mail, Fax, patient delivery of a printed hardcopy of the prescription, or any other comparable delivery method.

The prescription subsystem can monitor and resolve any post-dispensing issues such as accidental dispensing of the wrong medication or the return of unopened medications by patients. FIG. 9 shows an example process by which the system accounts for the return of a medication, for example, that has been dispensed accidentally. User login is required 902 for access to the subsystem. The medication return process is initiated 904 and the subsystem requests any necessary witnesses 906. For certain medications, a witness may be required to verify that the medication was returned to the dispenser. The subsystem allows the user to select the dispensed medication 908 by a number of methods. For example, the selection can be accomplished 908 by scanning the label bar code on the medication container or the subsystem can display a list of dispensed medications on the screen. The subsystem prints 910 a new label for the medication and then depending on the type of storage or dispenser unit proceeds as follows below.

If the medication is stored in a bin within a dispenser unit, the subsystem can send a control signal to open the door 912 for the bin pertaining to the medication. After the medication is returned the return transaction is recorded 914. The subsystem does not conclude the return process until the door to the bin is closed 916.

If the medication is stored in a smart dispensing device, the door for the dispenser is opened 920 in response to a control signal from the subsystem. The smart bin is released 922 and after the medication is returned the inventory is automatically adjusted 924 to account for the returned medication. The subsystem waits for the door to close 926 before the process is completed. Smart bin is term used to refer to dispenser units with “smart” technology, including “sense the take” technology.

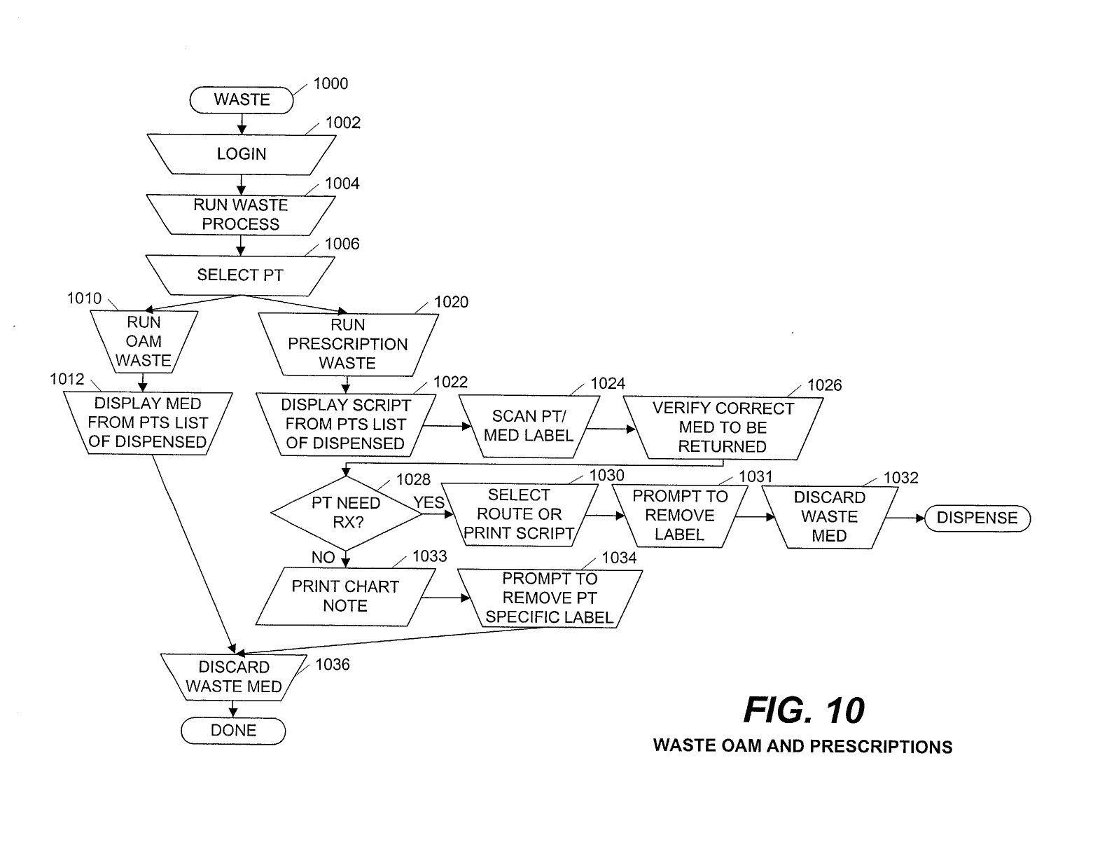

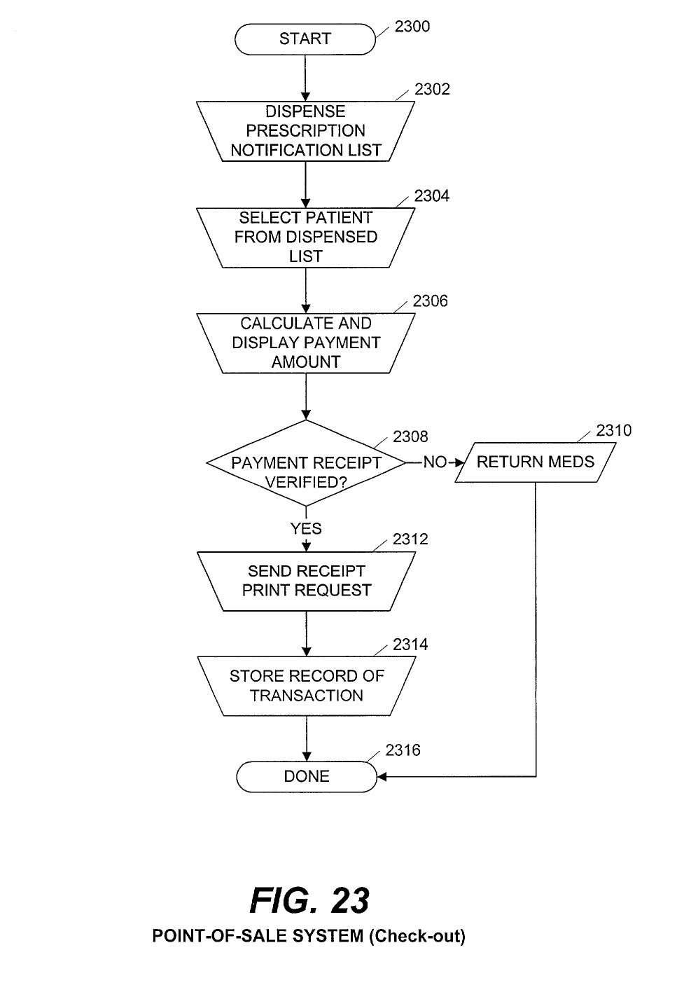

FIG. 23, which is discussed more fully below under the point-of-sale (POS) subsystem, shows an example process by which the POS subsystem credits a patient account for the return of medications that have been rejected by the patient. FIG. 10 shows how the system accounts for disposal of waste medications. The subsystem, like all others, requires user login 1002. After the subsystem initiates the waste process 1004, a patient list is displayed, from which a patient is selected 1006. Depending upon the medication that is to be discarded to waste, the subsystem can follow different routes. For a patient care item, the system initiates the office administered medication (OAM) process 1010. The subsystem displays a list of dispensed medications for the selected patient 1012. After the user selects from the display list the appropriate medication to be discarded as waste, the subsystem prompts the user to properly dispose of the medication 1036.

For a prescription medication, the system initiates the prescription waste process 1020. The subsystem displays a list of dispensed medications for the selected patient 1022 from which the user selects the medication to be discarded to waste. The prescription medication is then scanned 1024 to verify 1026 that the medication matches the medication selected from the display list. It should be noted that alternatively the user can manually enter the code from the bottle rather than scan the bar code. If the patient needs another prescription or a replacement prescription 1028, a new label is printed 1030, the user is prompted to remove the patient specific label 1031 and to discard the waste medication 1032, and the dispense process can be initiated, according to FIGS. 8A and 8B, for example. If no prescription is required 1028 by the user, the subsystem prints a note for the patient chart 1033, the user is prompted to remove the patient specific label 1034, and the user is prompted to properly dispose of the medication 1036.

Similar dispensing and post-dispensing procedures can be incorporated in the sample management, OTC-cosmeceutical, and patient care item subsystems. Although specific examples related to dispensing and post-dispensing procedures for the prescription subsystem have been shown disclosed herein, it is apparent to one skilled in the art that such dispensing and post-dispensing can be implemented in a variety of forms on any appropriate system or subsystem.

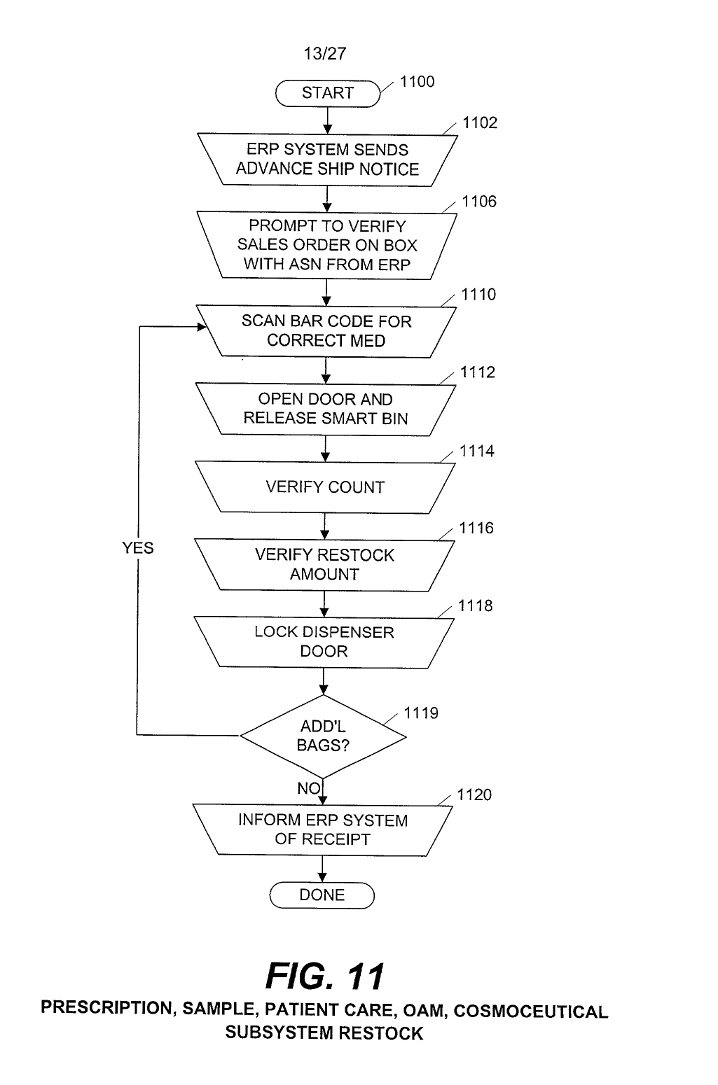

As with dispensing prescriptions, accidental dispense monitoring and medication return processes, there are a number of other tasks that are common to each of the medication and product dispensing subsystems. FIGS. 11-18 provide illustrative examples of some of the potential tasks, such as, monitoring inventory (physical and virtual), eliminating expired medications, reordering medications, selecting new medications for inventory monitoring, loading medications into dispenser units, unloading medications from dispenser units, recalling specific medication lots, and accessing medications in an emergency.

FIG. 11 is a task flow diagram of the restock process. Prior to shipping a product or medication, the subsystem provides to the medical office from the ERP system an advance shipment notice (ASN) 1102. Prior to restocking the product, the system prompts the user to verify that the information on the sales order slip on the shipping box matches the advance shipment notice 1106. Next the system scans the bar code on the packaging bag for the product 1110. The system opens the dispenser door and releases the smart bin 1112. The system requires verification of the product count 1114 and the restock amount 1116. The user refills the smart bin and returns it to the dispenser. The dispenser door is locked 1118 and if there are additional products to be restocked 1119, the procedure is repeated starting at block 1110 for the next product or medication. If no additional medications are to be restocked 1119, the system notifies the ERP of the receipt of the product 1120. If necessary the process depicted can vary depending on the circumstances of the particular item to be restocked. For example, the sample management subsystem may vary the process where samples may be shipped or delivered directly by a pharmaceutical company representative, rather than through the ERP system. In such a case, the ERP system may not send advance shipping notice, etc. Other possible variations are apparent to one of ordinary skill in the art.

The system, and prescription subsystem in particular, can include inventory control and management processes and systems for individual medical office system users as well as for offices with multiple users that each have separately owned inventories that are stored together. The system can include methods and apparatus for automated management of a third party's inventory. More specifically, separate from but working in conjunction with the physical inventory control can be “virtual” inventory for each party that owns product in the storage and dispensing units. Virtual inventory can automatically track ownership and utilization of products and manage physical product inventory where inventory is owned by more than one owner and is physically stored co-mingled in automated dispensing and storage units.

There are conditions in which individual parties operating together in a common physical space need to keep separate the ownership, accounting, and management of product storage and dispensing. The need for separate management may arise from, among other things, regulatory needs, business practices, and security issues. The scarcity of available space in some of these environments can inhibit the deployment of individual automated inventory control and dispensing systems for each party. The amount of space required by individual systems can increase by as much as 100% per party in the worst case. Therefore it may be desirable to be able to take advantage of shared storage space, yet maintain the individual control, management, and accounting of inventory movement.

The present system addresses these limitations of automated inventory storage and dispensing systems for inventory management and tracking where separately owned inventories are stored together in a common unit. Virtual inventory function with the prescription subsystem for example. The subsystem can record the current amount of product owned by one party, where parties store separately owned inventories in a common physical storage location. The current amounts owned by each party are recorded separately from total quantities of product stored in particular storage locations. Then the subsystem can initiate product dispensing subject to the virtual inventory of the particular party.

The physical storage and control of inventory can be achieved with the combination of electronic hardware and software components. Access to the products stored in the units can be controlled by the individual user, product, or storage devices, and the like. Physical inventory control processes of the present system can manage the tracking of lot numbers, expiration dates, and other attributes of the products as they are stocked and dispensed from the system.

Inventory quantities for each ownership party can be stored and managed independently of the physical inventory and separate from each other. In addition, the parameters for determining demand planning needs for each party (e.g. reorder frequency, safety stock, historical utilization, etc.) can be maintained individually. The subsystem can achieve stock management by individual party without the need for dedicated storage locations for each party. The product stock can be physically stored together while the record of who owns how much is tracked separately and independently of where the stock resides.

As product is dispensed or restocked on behalf of an owning party, that party's virtual inventory can be adjusted accordingly. The ability for a party to dispense a product from the system is controlled by the quantity of product that the owning party has remaining in their virtual inventory, not simply the physical availability of the product in the storage and dispensing unit.

The system can generate restocking requests for each participating party individually. The restock or reorder requests can be made as described more fully herein. Each such request may be subject to approval by the party prior to fulfillment of the request via a sales order and shipment. The subsystem can combine the orders for all of the parties into a consolidated delivery that is routed within the facility to the appropriate storage device while maintaining the separation of the individual orders. Each party's order can be wrapped separately within the delivery package and labeled to indicate ownership of the product, quantity and sales order number.

Even as reorder quantities are individually calculated for each party based upon their needs, the physical constraints of the storage and dispensing units can be taken into consideration. The subsystem can be configured so that it will not ship more product to a facility than the facility has capacity to store in the dispensing units.

When a physical inventory count results in a deviation from the system's predicted values, there needs to be a corresponding adjustment to the virtual inventory record for the affected party. In this case, the subsystem keeps track of such deviations in an adjustments record that can be applied to all parties until a knowledgeable person can assign responsibility through a discrepancy resolution process. During the time in which a discrepancy is outstanding, each party can have their virtual inventory reduced by the net amount of outstanding deviation for the determination of the ability to dispense the product from the system.

The process of discrepancy resolution between a physical inventory count and the system's count can include the determination of which of the owning parties' stock is affected. Once the outstanding discrepancies for a product have been accounted for, the subsystem can discontinue applying an adjustment to each party's virtual inventory.

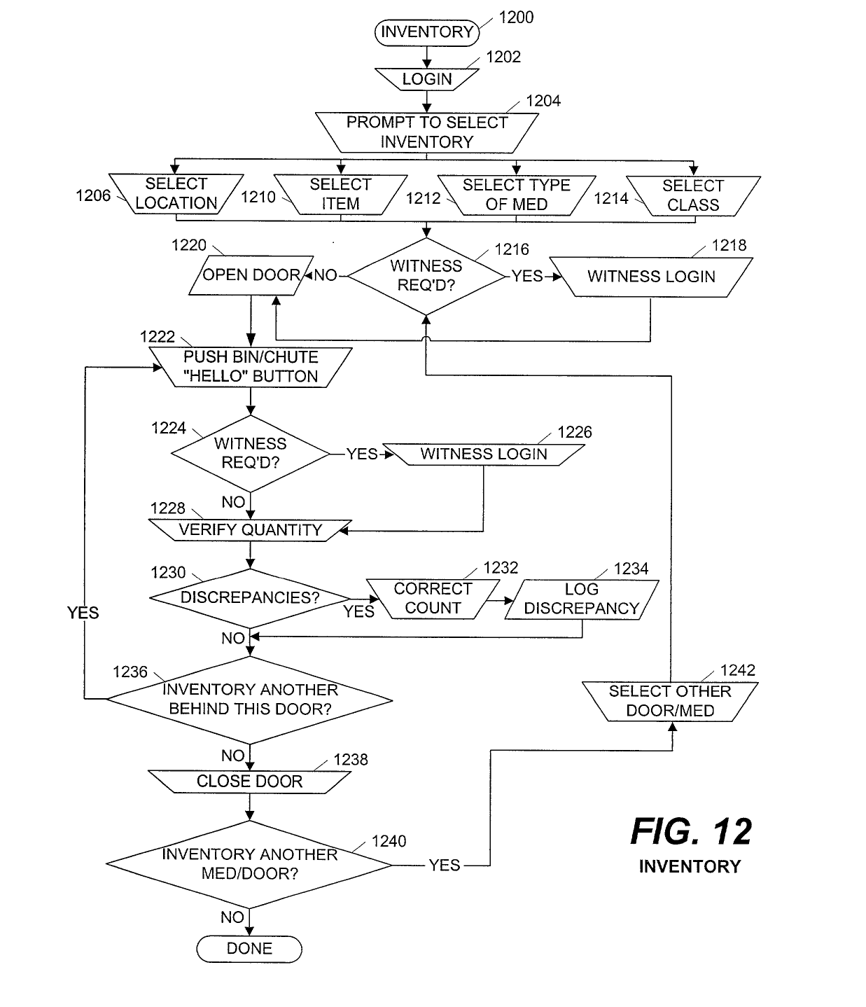

FIG. 12 illustrates one process for inventory management and control. After login 1202 and inventory process initiation 1204, the subsystem permits the user to check inventory at a specific location 1206, for a selected item 1210, for a specific type of medication or product 1212, or for a specific class of medication 1214. It should be noted that these criteria are exemplary only and do not represent all possible criteria. If a witness is required 1216, the subsystem will permit login 1218 after which the subsystem opens the appropriate dispenser door 1220. Witness login can occur once at this point for all of the selected inventory categories. Any witness added after this initial selection point may require an additional login prompt from the subsystem. If no witness login is necessary, the subsystem opens the dispenser door 1220. Next, the subsystem waits for the user to acknowledge the “hello” button on the dispenser or bin 1222. In some cases the subsystem can require that the user scan the bin prior to the button push. If there are medications in the bin necessitating different witness requirements, then another witness prompt can be displayed 1224.

After the button is pushed 1222 and after witness login 1224, if required, the subsystem requires input of the actual medication or product quantity in the dispenser 1228. The subsystem verifies that the quantity actually in the dispenser matches the quantity recorded in the system 1230. If there are discrepancies 1230, the count is corrected 1232 in the subsystem and the discrepancy is logged 1234. After logging the discrepancy 1234 or if there are no discrepancies, the subsystem repeats the inventory process at step 1222 if there are additional medications to inventory in bins within the same dispenser 1236. If no additional inventory is to be checked in the same dispenser, the subsystem ensures closure of the door 1238. The subsystem then queries 1240 whether the user wants to check the inventory of another medication. If another inventory is to be checked, the subsystem prompts for selection of another medication or door 1242. The process is then repeated starting at step 1216. If no other inventory checks are to be performed the process is complete.

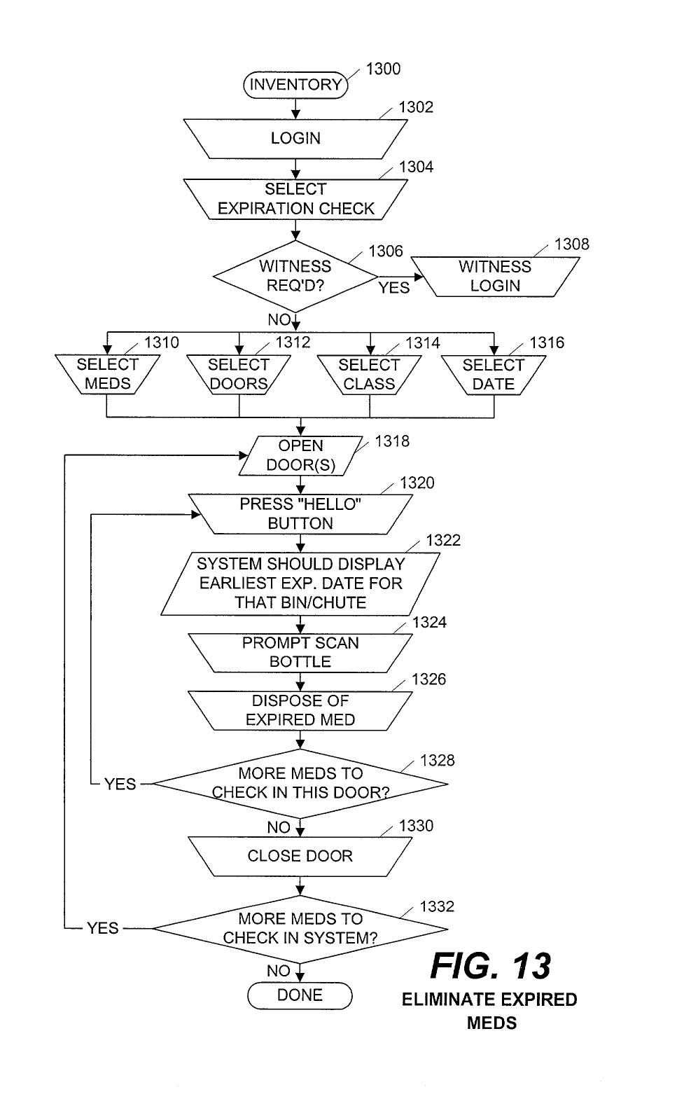

FIG. 13 shows the process eliminating expired medications and products from inventory. After login 1302, expiration check process initiation 1304, and witness login 1306, 1308 if required, the subsystem permits the user to check for the expiration of a specific medication or product 1310, behind a specific dispenser door 1312, for a specific class of medication 1314, or a specific date 1316. The subsystem then opens the appropriate dispenser door(s) 1318 and prompts the user to press the “hello” button 1320. The subsystem displays 1322 list of expiration dates for the user selected bin within the door. The subsystem can display a list of the product having the earliest expiration date in the particular dispenser bin or chute 1322. The user can then determine which medications or products have expired by checking the dates on the individual packages, for example. The subsystem prompts the user to scan 1324 any expired medications and then directs the user to appropriately dispose of the medication 1326. If there are additional medications to check 1328 within the same open unit, the subsystem directs the user is again select the desired bin (press “hello” button 1320) and process repeats at step 1322. If there are no additional medications to check 1328, the subsystem ensures that the unit door is closed 1330, then determines if the user desires to check additional medications in the system 1332. If there are, the process is repeated beginning at step 1318. If there are no additional medications to check for expiration 1332, the process is complete.

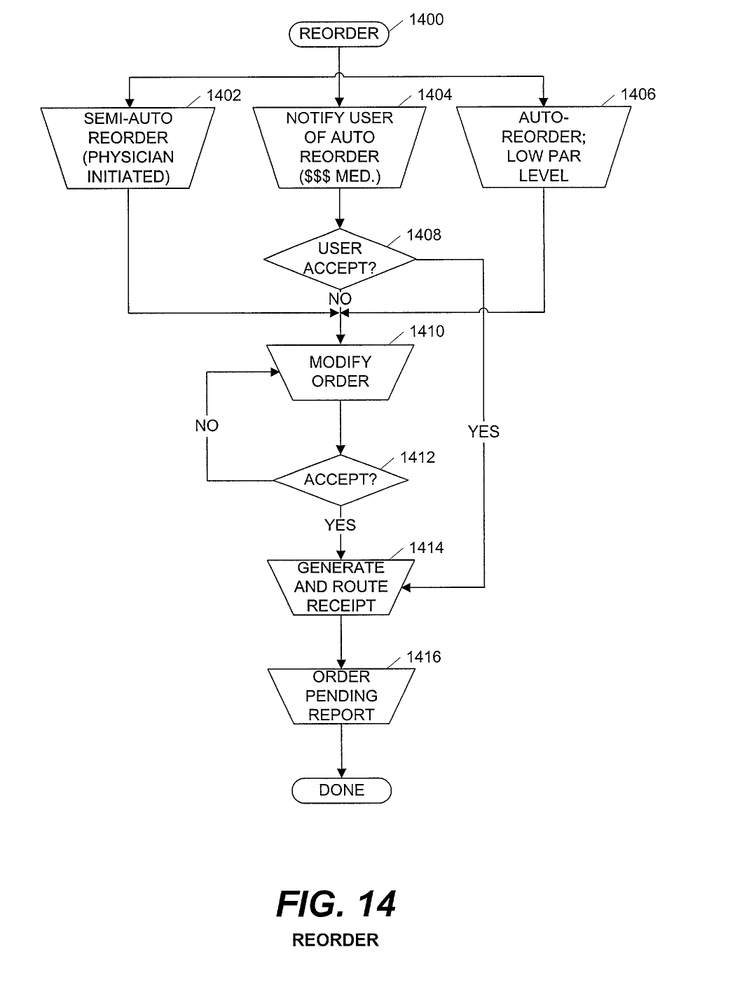

FIG. 14 is a task flow diagram of the process for reordering medications. The system can initiate reordering by several methods. One method is the semi-auto reorder 1402 method in which the physician can initiate the process when inventory is low or in order to obtain a new medication, for example. The subsystem can auto reorder based upon a predetermined level or a par level 1406 of a product. Under either of these cases, the subsystem then permits the user to modify the order 1410. If the user does not accept the modified order 1412, then the subsystem permits the user to modify the order again 1410 and the subsystem again prompts for acceptance 1412. If the user accepts the modified order 1412, the subsystem completes the process by generating and routing a receipt for printing 1414 and creates an order pending report 1416.

Reordering can also be initiated by an auto reorder process in which the subsystem notifies the user 1404 and seeks approval 1408 of the user prior to proceeding with the order. If the user accepts the order 1408, the subsystem generates and routes a receipt for printing 1414 and creates an order pending report 1416. If the user does not accept the order, then the subsystem permits the user to modify the order 1410. If the user does not accept the modified order 1412, then the subsystem permits the user to modify the order again 1410 and the subsystem again prompts for acceptance 1412. If the user accepts the modified order 1412, the subsystem completes the process by generating and routing a receipt for printing 1414 and creates an order pending report 1416.

As discussed reordering can be initiated in response to inventory levels reaching a par level. A par level can be an arbitrary inventory level that is set by the user or by the subsystem. For example, the subsystem can dynamically set par levels based upon inventory usage of the user. Also, the dynamic par level can be determined based upon factors such as the daily product dispense amount, the time period from sending a reorder request until the filled order is received by the user, and the margin of overstock or inventory capacity of the user, for example. One skilled in the art will recognize that various other factors can be used as well.

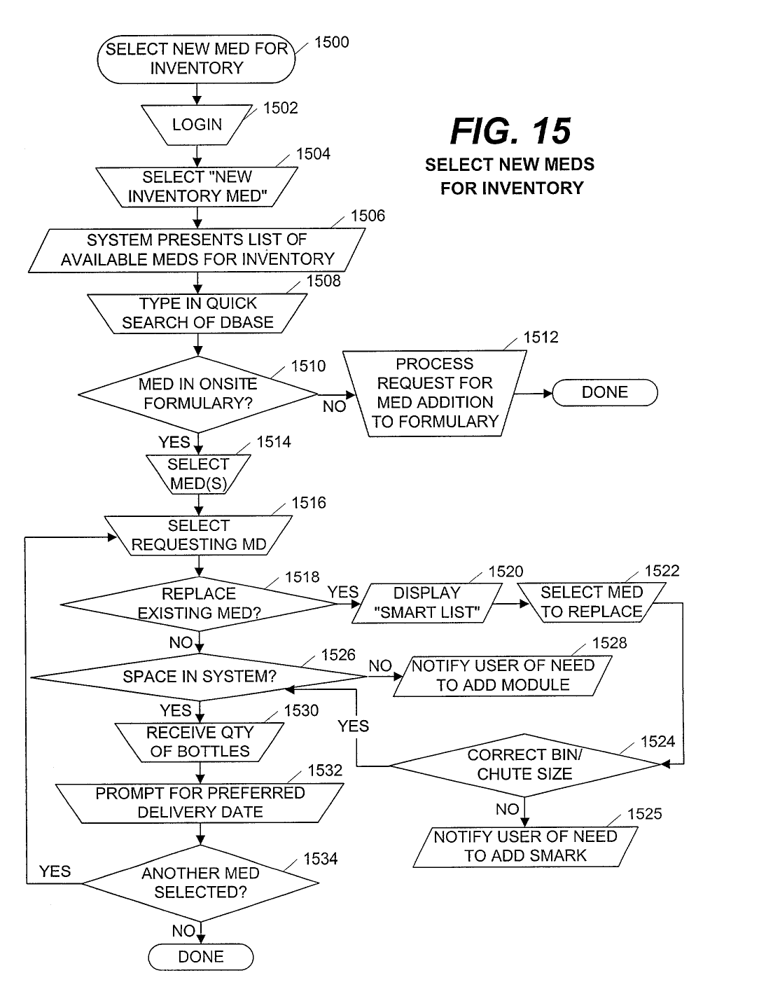

FIG. 15 is a task flow diagram of the process for selecting new medications to add to inventory. The subsystem displays a list of medications that are available for addition to inventory 1506. The list can be based upon the central system formulary list of medications, for example. The subsystem can also perform a quick search 1508 of the database based upon medication name and/or manufacturer, for example. If the medication is not in the central system formulary list 1510, then the subsystem can process a request by the user for medication addition to the formulary 1512. If the medication is on formulary 1510, the subsystem then prompts for selection of the medication 1514 and for selection of the requesting physician 1516.

The subsystem asks the user if an in stock medication is to be replaced 1518 by the new medication. The answer to this query may trigger the central server to send return authorization and other relevant materials to the physician office. If there is a current medication to replace, the subsystem displays a “smart list” 1520. The “smart list” can include a display of information for the user, such as the average number of prescriptions written per day, chute and bin sizes, the maximum quantity for the new medication, the h/w limitation, and the like. The “smart list” can allow the user to sort the list by medication, class, size of bin or chute, and the like. After the user inputs a selected medication for replacement 1522, the subsystem then determines if the system has a bin or chute of a correct or appropriate size for the new medication 1524. If none is available the subsystem notifies the user of the need to add an addition storage unit bin or chute 1525, which is designated generically as a “SMARK.” The smart list allows the user to sort the list be medication, class, size of the bin or chute, and the like. If the system has an appropriate bin or chute, the subsystem then determines if there is available space in the system for the medication 1526. At 1518, if no current medication is to be replaced, then the subsystem determines 1526 if there is dispenser capacity to accommodate the new medication.

At 1526 if the system lacks space, the user is notified of the need to add an additional module 1528. If space is available, the system prompts input of the medication quantity 1530 and the preferred delivery date 1532. If additional medications are to be added 1534 the process repeats beginning at step 1516. The process is complete if no additional medications are to be added.

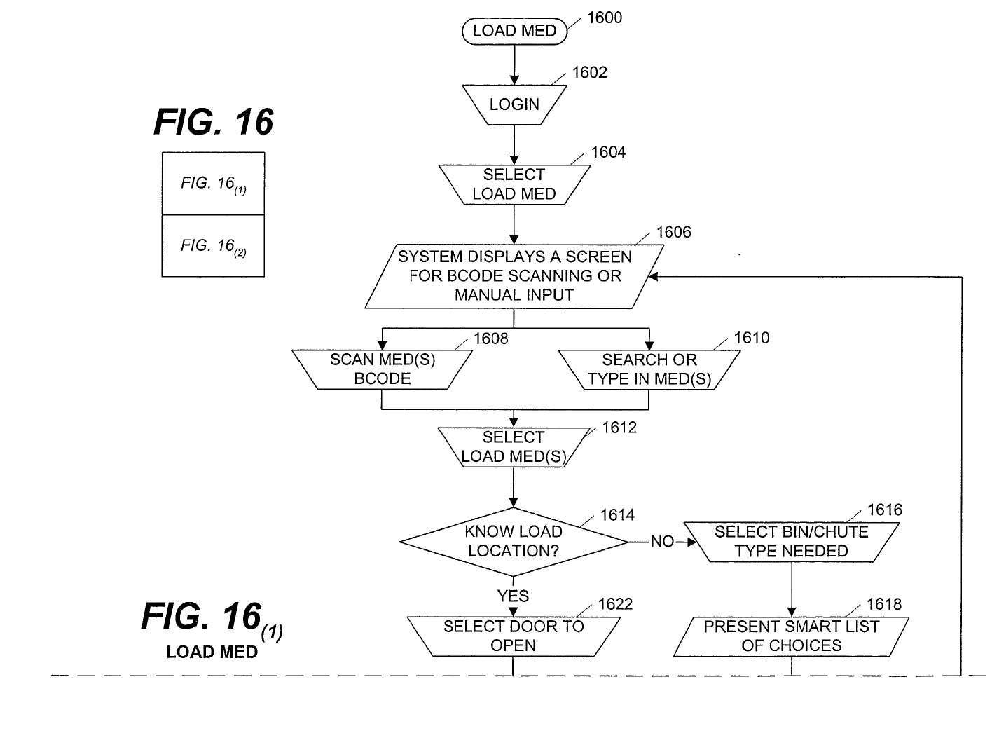

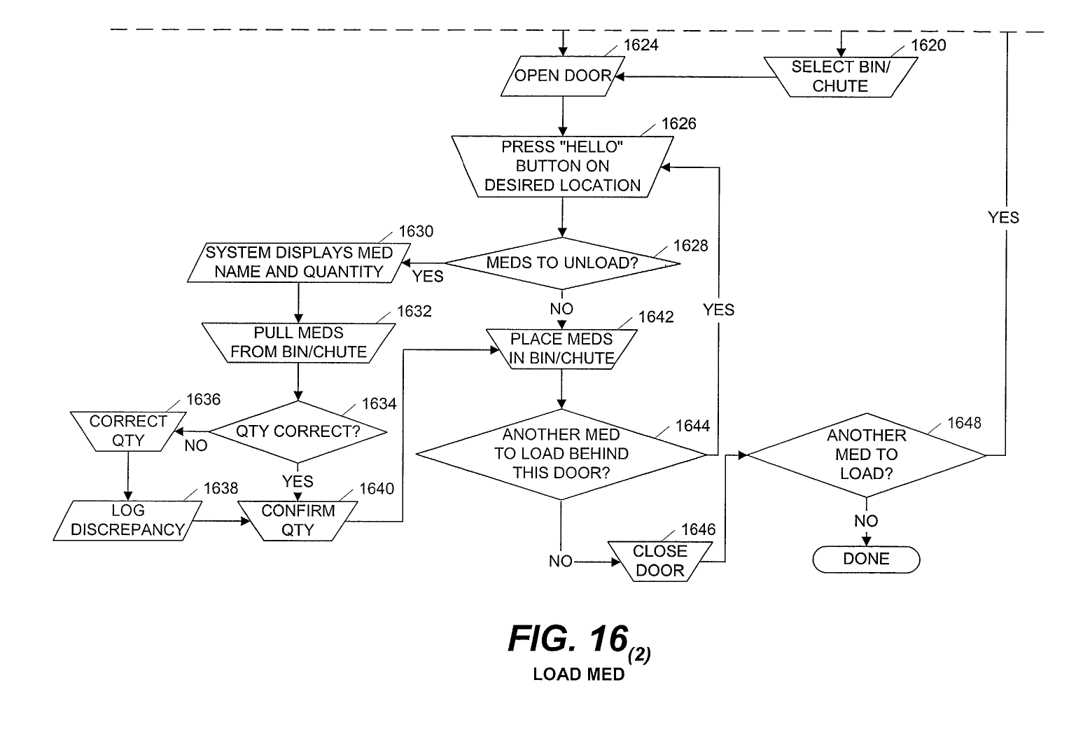

FIG. 16 is a task flow diagram of the medication loading process. The subsystem allows the user to scan the medication bar code or to manually input the code 1606. After either receiving the scan 1608 or manual input 1610 of the code followed by confirmation that the selected medication is to be loaded 1612, the subsystem queries for a determination of the load location 1614. If the location is already determined, the user indicates the correct door for loading 1622 and the subsystem opens the door 1624. If the load location has not been determined, the user is prompted to select the type of chute or bin that is needed 1616. A “smart list” as described above can be presented 1618 at this point, as well, to aid the user in making the selection. After the subsystem receives the user selection of the bin or chute 1620, the subsystem opens the door.

The user is prompted to push the “hello” button for the specific load location 1626. If no medication is to be unloaded, the subsystem proceeds to the loading step 1642 as described below. If medication needs to be unloaded 1628, the subsystem displays the medication name and quantity 1630 and instructs the user to remove the medication from the bin or chute 1632. The subsystem verifies that the quantity removed matches the quantity in the subsystem records 1634. If there is a discrepancy, the actual quantity is corrected in the subsystem 1636, a discrepancy is logged 1638, and the new quantity is confirmed 1640. If the quantities match 1634, the subsystem confirms the quantity 1640. Next, the user is instructed to load the medication into the bin or chute 1642. When finished the subsystem asks whether there is another medication to load into the particular open dispenser door 1644. If additional medication needs to be loaded, the process repeats beginning at step 1626. If no additional medication is to be added, the subsystem awaits door closure 1646, then determines if another medication needs to be added to a different dispenser unit 1648. If another needs to be loaded, the process repeats starting at step 1606. If no medication is to be loaded, the process is complete.

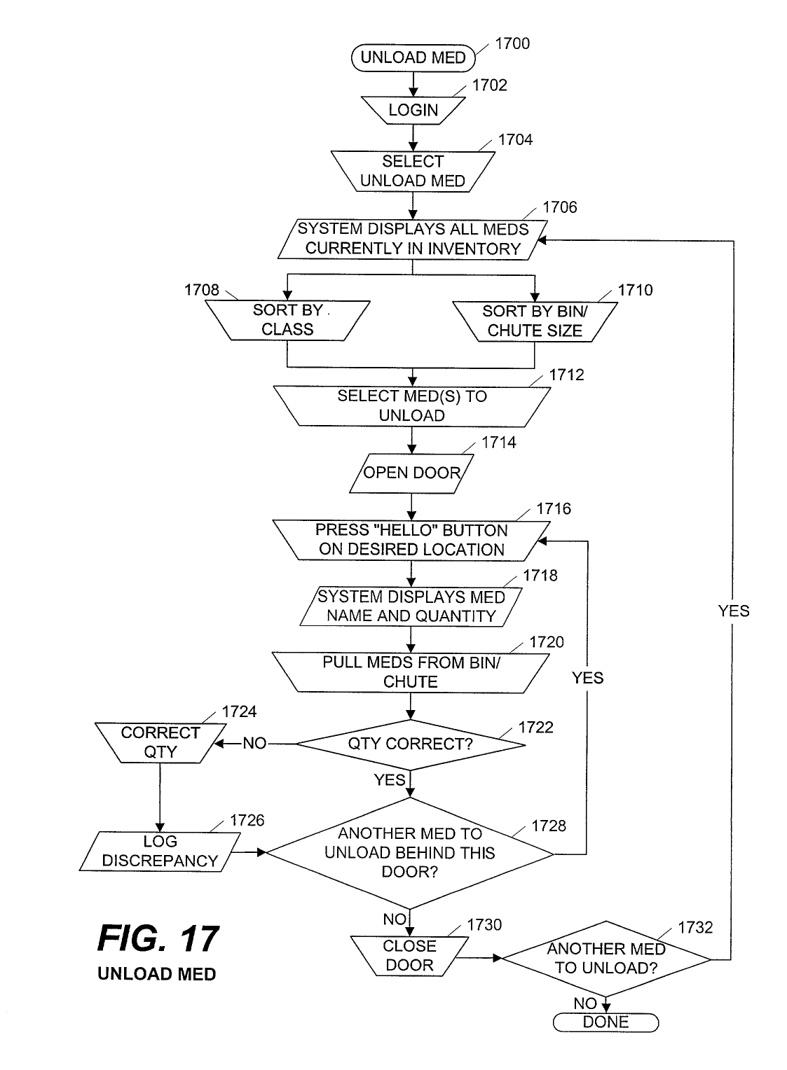

FIG. 17 is a task flow diagram of the process for unloading medications from a dispenser. The unload medication process is initiated 1704 and the subsystem displays all the medications currently in inventory 1706. The subsystem can sort the medications by class 1708 or by bin/chute size 1710. The subsystem is not limited to these methods of sorting, but these are shown to provide exemplary methods. The user indicates to the subsystem which medication to unload 1712 and the subsystem opens the dispenser unit door 1714. The user is prompted to press the “hello” button on the desired location within the dispenser 1716. The subsystem displays the medication name and quantity for the selected location 1718.

Next, the subsystem instructs the user to remove the medication 1720. The subsystem verifies that the quantity removed corresponds to the quantity of medication listed in the subsystem 1722. If there is no discrepancy, the subsystem proceeds to step 1728. If there is a discrepancy, the correct quantity is updated 1724 and the discrepancy is logged 1726. At 1728 the subsystem asks if the user wants to unload another medication from the open dispenser unit. If yes, the process repeats starting at step 1716. If no, the door to the dispenser is closed 1730 and the subsystem asks if the user wants to unload another medication from a different dispenser unit 1732. If yes, the process repeats starting at step 1706. If no, the unload process is complete.

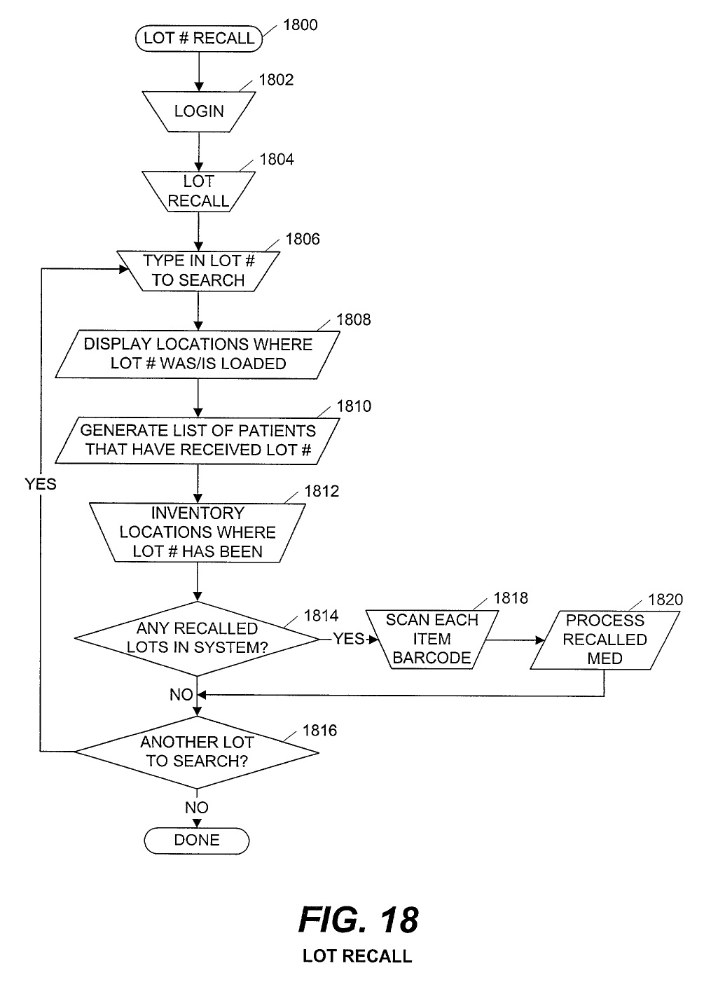

FIG. 18 is a task flow diagram of the process for recalling specific lots of medications. The subsystem initiates the lot recall process 1804 and prompts the user to enter a recalled lot number 1806. The subsystem then displays or lists the locations of medications 1808 for the particular lot number. The subsystem can also generate a list of patients 1810 that have received medication from the recalled lot number. The user is directed to check the inventory at the locations where the lot numbers are located 1812. If there are recalled medications in the dispenser system 1814, the user is directed to scan the barcodes or enter the codes from the items 1818 and the medication is processed 1820 according to recall instructions. After processing the recalled medication 1820 or if there are no packages of the recalled medication presently stored in the dispenser system 1814, then the subsystem permits the user to search for another recalled lot number 1816. If another search is initiated, the process repeats, starting at step 1806. Otherwise the lot number recall process is complete.

The prescription subsystem has been described and illustrated by reference to various functions and embodiments One skilled in the art will recognize and understand that additional functions and embodiments, including those common in the art, may be included herein as well.

Patient Care Item Subsystem

The patient care item subsystem can assist the back office clinical staff with aspects of patient care item management. The subsystem includes the dispensing of office administered medications (OAM's), such as vaccines, and the like. The subsystem can be responsible for inventory control, ordering, and dispensing. Due to the fact that this subsystem is in the office workflow with the other subsystems, the addition of the patient care item subsystem automates almost all of the clinical staff inventory responsibilities. As with all of the other subsystems, such as, the OTC subsystem, the prescription subsystem, and the sample management subsystem, the patient care item subsystem can capture inventory levels and provides automated re-ordering functionality along with reports to track dispensing practices and trends. Further, the subsystem can be configured and adapted to include other functionalities, many of which are described herein with reference to other subsystems.

Over-the-Counter Medications and Cosmeceutical Subsystem

The OTC medication subsystem and cosmeceutical subsystem can assist the physician office staff with inventory, management and financial reporting as related to the dispensing of non-prescription drugs. This subsystem achieves its function both by allowing the input of relevant patient and medication information and by automatically tracking the dispensing of these drugs from the OTC dispenser unit. Both the data obtained automatically and through user input can be processed and stored by the front office server where it can be used generate reports that can be accessed from various points along the system. It should be noted that the OTC subsystem and the cosmeceutical subsystem are discussed as separate subsystems. However, the subsystems could be combined into one as cosmeceuticals can be considered to be a subset of over-the-counter products. In fact over-the-counter products can include cosmeceuticals, nutriceuticals, and other like items that are obtained “over-the-counter.”

To facilitate the tracking and dispensing of OTC medications and cosmeceuticals the OTC medication and cosmeceutical subsystems allow authorized users to dispense OTC medications from various system access points. As a result, office staff members can perform tasks, such as, updating patient records to reflect OTC sales, tracking inventory and dispensing OTC medications from a number of office locations. For instance, a clerk can enter the entire OTC transaction from the reception kiosk or at the point of dispense. Alternatively, a doctor, or other authorized office staff member can enter the relevant information from a back office kiosk that is attached to the local network. The patient can then receive her medication at the front desk before leaving the office. As a result of this flexibility in tracking and dispensing of OTC medications, multiple OTC and cosmeceutical dispenser units are often utilized. Alternatively, the dispenser component of the OTC subsystem can be placed in a central location or in an area where the majority of the dispensing occurs. Such a design allows for physician office workflow nuances and provides the necessary information flow to efficiently handle OTC medication and cosmeceutical dispensing requirements.

Sample Management Subsystem

The system disclosed herein also can include a sample management subsystem which through automated data collection and limited user input can track the receipt and dispensing of sample medications that are provided to the physician office by pharmaceutical companies. The subsystem can also determine if a sample medication is appropriate and safe for a patient, track sample medication usage, and transmit a dispense signal to the one or more dispenser units directly or indirectly to dispense a sample, for example. For example this can be done by relating patient information and prescription information (if necessary) and by initiating a drug utilization review utilizing such information. The sample management subsystem achieves its functions by moving much of the burden of data input from the user to hardware and software technology. There are key elements of user workflow that the sample management subsystem automates for users, such as, identity of the sample removed, sample quantity removed, sample lot number, patient name, and expiration date. However, some data elements must be entered by the user, such as, the access code (password and fingerprint), International Classification of Disease, version 9 (ICD-9), clinical data elements, and the like.

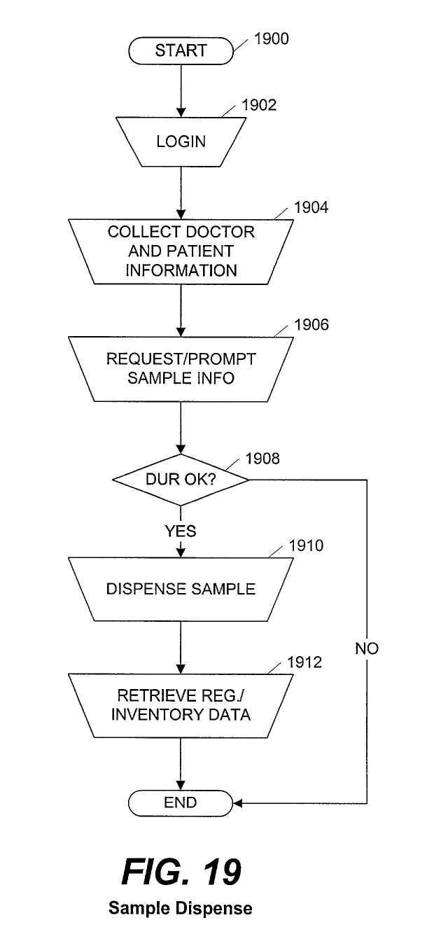

For example, the sample management subsystem collects data regarding sample usage first from the required user input, which can be entered from any computer that is attached to the local network, then from the automatic recording of specific information, such as, when the medication is removed from the sample dispenser unit. FIG. 19 is a task flow diagram of a possible sample dispensing process. The gathered data can be delivered via the local network to the front office server where it is stored and transmitted via the Internet to the central server. The central server can further process the collected data and maintain separate databases containing either raw or processed data. The processed data can be used to generate useful reports. Processed data reports provide users, such as, pharmaceutical companies and physicians with data regarding sample medication usage patterns, sample inventory levels, regulatory compliance information, and other like information.

Because the central server also can be a website host, pharmaceutical representatives can access specific sampling reports by accessing the appropriate website through any web browser. For example, a pharmaceutical representative can access the system through a web browser linked to the central server through the Internet. The server can be configured to grant such a client access only to the categories of information that are available to the pharmaceutical representative user group. Furthermore, the specific users within a group further can be restricted to information to which they subscribe. Examples of accessible information for this particular user group are, data regarding patterns distribution of drug samples by individual physicians, real time sample drug inventory remaining in each physician office, reports regarding the effectiveness of targeted detailing, sample distribution by patient or diagnosis code, the status of specific medications by lot number or expiration date, and the like.

The sample management subsystem also can help the physician office to achieve complete regulatory compliance with respect to the dispensing of sample medication. Regulations issued by JCAHO require specific information, such as, sample lot number and expiration date to be captured for each sample dispense, but most physician offices do not follow these regulations to the full-extent. Since the sample management subsystem captures sample information with a limited user interface, sample dispensing can be performed without dramatically changing user workflow. In other words, this subsystem automatically collects much of the required regulatory information, while leaving the user to enter only a few essential items. This method enables rather than forces the physician to be in regulatory compliance.

To facilitate rapid sample dispensing, the present system allows an authorized user to dispense samples without entering regulatory information. By default, access to the sample dispenser units is restricted prior to the subsystem's receipt of sample lot number and expiration date so as to ensure that all necessary sample data is entered into the system. However, to achieve dispensing flexibility the subsystem can employ logical software toggles (switches) which allow the physician or other appropriate user to reversibly disable subsystem prompts that require manual entry of sample data before allowing the medications to be dispensed.

FIG. 19 is a task flow diagram of the sample dispensing process. After login by an authorized user 1902 and collection of doctor and patient information 1904, the subsystem requests or prompts for sample information 1906. After information on the specific sample to be dispensed is received, the subsystem performs a DUR check 1908, for example, to ensure compatibility of the sample with other medications that the patient may be receiving. If the DUR check 1908 shows possible adverse interactions, the user can be notified of potential issue and the user can determine how to proceed. This may include declining to issue samples to the patient. If the DUR check 1908 shows no adverse interactions, then the samples are dispensed 1910 and the subsystem retrieves and processes any regulatory and inventory data 1912.

The dispensing unit for sample medications can be designed to operate within the current physician office cabinetry. The dispensing unit is able to conform to the many different cabinet configurations because the hardware/software design provides a high level of configurability and flexibility. Even while providing this extensive flexibility, the system design enables easy setup and installation.

Marketing Subsystem

The marketing subsystem helps pharmaceutical and other companies gain the attention of the physician and office staff by allowing the these companies to integrate targeted information into the daily work routine of the physician office. Gaining access to the physician and physician office workflow provides opportunity for many different channels of service delivery. One function of the marketing subsystem can be to provide services, such as, providing appropriate and targeted eCoupons, eDetailing of physicians and other office staff, survey administration and banner advertising.

One service that the present subsystem can provide is eCoupon promotions. Such coupons can be pushed to the physician office through Internet technology and subsequently delivered to patients. Some eCoupons are global, and thus, they can be pushed to every patient. The majority of eCoupons, however, are targeted to specific patient groups, medications, disease states, or physicians. Based on data gathered from numerous physician offices which participate as part of the system disclosed herein, eCoupon sponsors can select the most appropriate target audiences for their promotions.

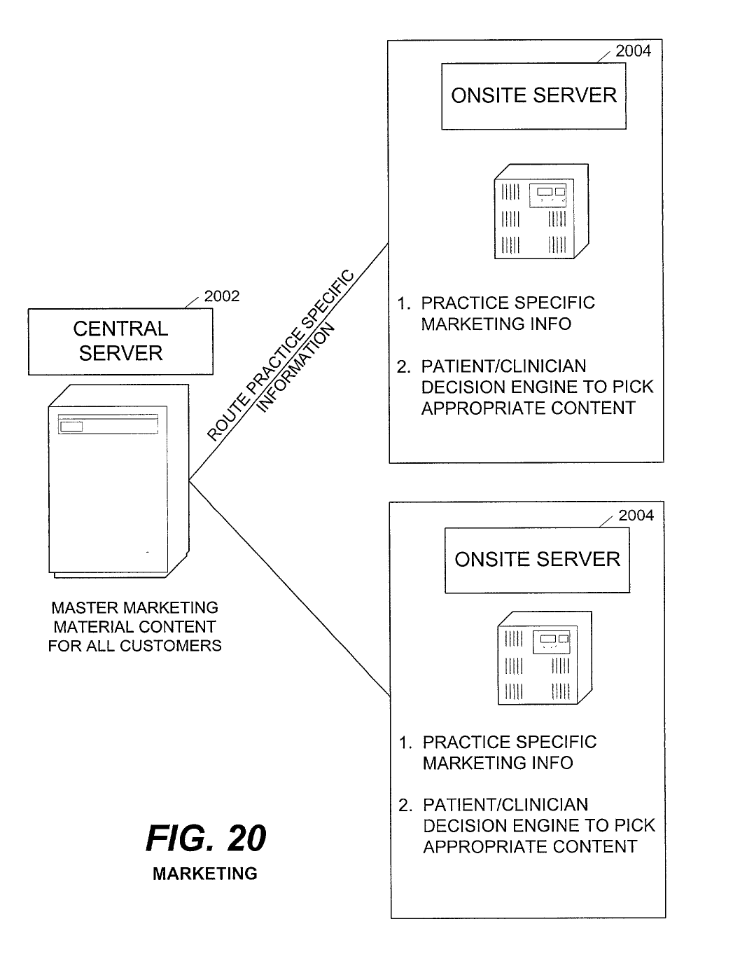

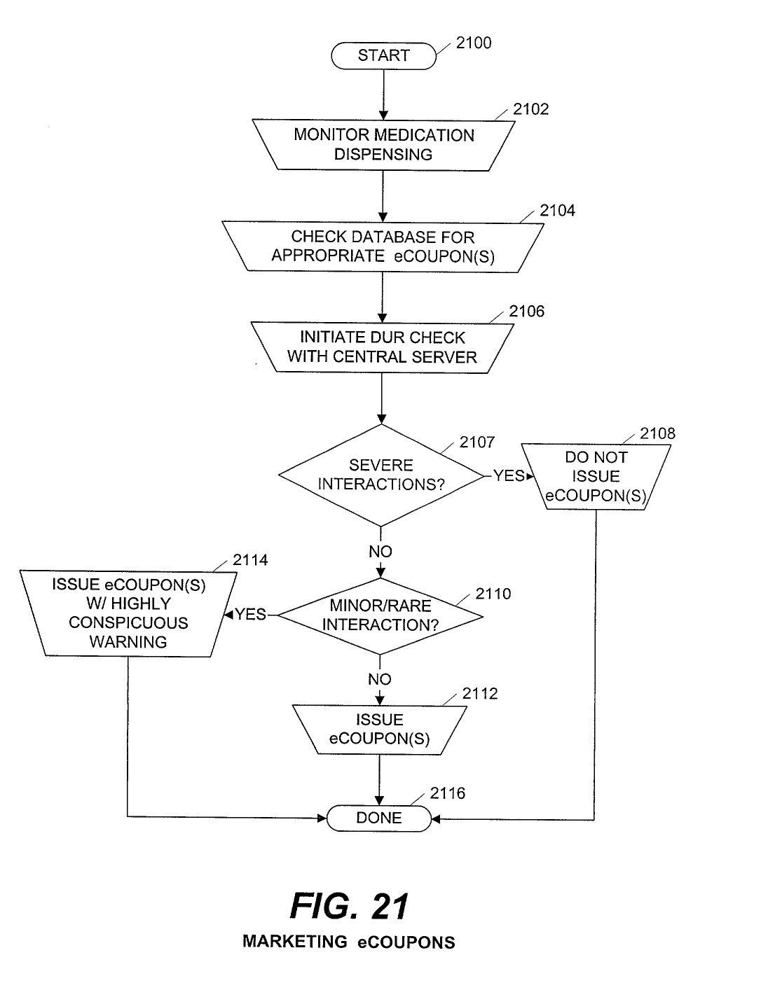

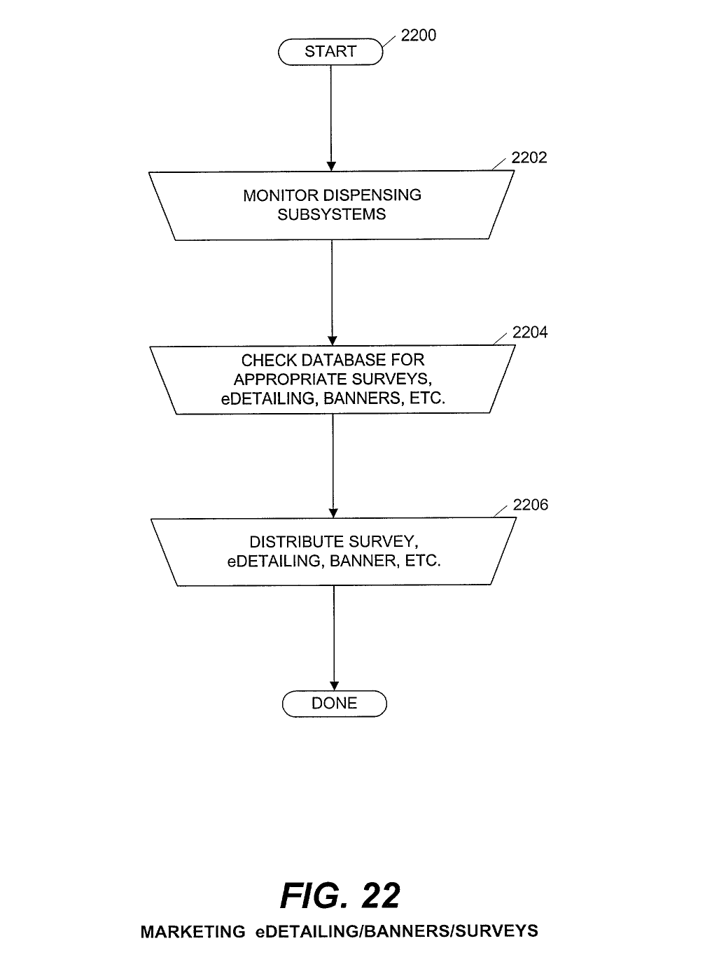

FIG. 20 illustrates one possible marketing distribution process. The central server 2002 can include the master marketing material content for all users or customers. The central server 2002 routes the marketing information to the front office servers of the users or customers 2004. The users and customers can include medical office system users and the like. The central server routes general or global marketing information as well as targeted or client practice specific marketing to the front office servers 2004 of the users. The front office servers can also include a patient/clinician decision engine in order to select and route appropriate marketing content to users. The decision engine can select and route marketing content based upon a prescribed medication, a disease state, physician practice, patient groups, and the like, for example. The decision engine process is discussed in more detail below in relation to FIG. 21 and FIG. 22.

eCoupons can be pushed to the care provider at the time of dispensing the patient's product. For example, the marketing subsystem can provide for immediate eCoupon dispensing by maintaining a continuously updated database of specific eCoupon promotions on the central server. At the medical office, prior to each approval to dispense a medication, the front office server can communicate with the central server to determine appropriate eCoupons for retrieval. Upon retrieval, the front office server can either process the eCoupon electronically or provide a hard copy of the eCoupon at the time the medication is dispensed.

The following provides an example description of a targeted eCoupon delivery. The central server maintains a database of all market drug products for appropriate retailers and service providers. From their own list of products, each retailer and service provider chooses the products or services to be promoted and the duration of the promotion. Prior to the dispensing of a medication at any physician office, the central server receives a request to check the database for any appropriate eCoupons. In the search of its database, the central server might find several eCoupon matches, such as, a promotion for the specific medication being dispensed, a promotion for an OTC medication that ameliorates one of the side effects of the medication being dispensed, and a promotion for a disease management program that would likely benefit a patient taking the medication being dispensed.

The preceding example represents one possible targeting method and is merely illustrative. One skilled in the art will immediately realize that the targeting of eCoupons can be achieved in any number of ways and numerous criteria can be used to judge whether a particular eCoupon is appropriate for a particular medication to be dispensed. Further, the content of the eCoupons can be diverse as well.

An additional feature of the disclosed system is its ability to ensure that any eCoupon that is pushed does not have a potential interaction with the medication that is dispensed. The interaction check can be accomplished by the central server, which houses a searchable DUR database containing regularly updated drug interaction data and other product information commonly used when performing drug utilization reviews. It should be noted that such a database can also be housed on the medical office system. To perform the check, each medication that a physician prescribes is matched with all appropriate eCoupons then all possible combinations of the prescribed medications and matching promotional medications are screened against the DUR database to determine potential interactions. If severe interactions between the prescribed and promotional medications are found, no eCoupon will be issued for the promotional medication. For certain minor or rare interactions eCoupons containing highly conspicuous warnings may be issued.

Referring to FIG. 21, illustrated is one possible process for distributing eCoupons. The marketing subsystem monitors medication and product dispensing 2102 within the physician office. For example, the monitoring can be done by a patient/physician decision engine, as described above or any other like method known in the art. When a medication such as a prescription or over the counter product is dispensed, the subsystem automatically checks the marketing content database for appropriate eCoupons 2104. For example, the eCoupon can be for an over the counter medication or consmceutical that alleviates side effects of the medication. Also, the eCoupon can include information for a disease management program. If an appropriate eCoupon is found, the subsystem initiates a DUR check 2106 with the appropriate server, which can be the central server, for example. The DUR check determines whether the eCoupon product has severe interactions with the dispensed medication 2107. No eCoupon issues 2108 if the subsystem determines that there is a potential severe interaction. If there are no severe interactions, the subsystem determines whether there are possible minor or rare interactions 2110. When there are possible minor or rare interactions, the marketing subsystem can issue an eCoupon with highly conspicuous warnings 2114 for the doctor and patient. If there are no minor or rare interactions, then the eCoupon can be simply issued 2112 to the doctor and patient.

The process of educating physicians regarding clinical outcomes, dosing patterns or new drug launches, known as detailing, is often crucial to the success of a drug line. The present subsystem can make the detailing of physicians much more efficient by means of a targeted and integrated instructional service known as eDetailing. This service can take many different forms, such as, video detailing, push detailing, pull detailing, and interactive detailing.

The subsystem collects and processes data related to the physician office utilization of eDetailing then uses the processed data to generate reports that are of interest to pharmaceutical companies. For example, the subsystem can track eDetailing utilization data to determine which forms of eDetailing are preferred by particular physicians. The present subsystem also can determine the efficacy of eDetailing with respect to individual physicians by analyzing changes in medication ordering patterns of physicians in response to targeted eDetailing. In addition to reporting the results of eDetailing utilization, the system also can use the form and efficacy data to learn which methods work best for each physician and then automatically adapt eDetailing efforts to those that are most effective.

Another service that the marketing subsystem can provide is administering clinical surveys and then compiling and reporting the results. In certain cases the marketing subsystem can electronically push clinical surveys into the physician office. Such pushing can be active, such as, requiring survey completion before certain medications can be dispensed, or passive, such as, transmitting survey questions to the front office server and posting reminders that request appropriate office staff to complete surveys at their soonest convenience. Other surveys can be pulled from the central server based on each physician's interest. Since pull surveys are available to physicians and office staff at all times, they are able to complete surveys of interest at times that are most convenient for them.

By utilizing computer generated screens in conjunction with physical control to manage inventory, the marketing subsystem provides the opportunity to push non-invasive information, in the form of banners, to the care provider. The central server can utilize collected data regarding characteristics, such as, physician prescription habits, office staff ordering trends and completed survey data to select appropriate banners in which to transmit for display at appropriate times.

FIG. 22 is a task flow diagram of the process of eDetailing, banner advertisements, and clinical surveys. The marketing subsystem monitors 2202 the various dispensing subsystems, including prescription, sample, OTC, consmeceutical, and patient care subsystems. When a product or medication is dispensed the subsystem checks 2204 the database for an appropriate eDetailing content including a survey, a banner, clinical information, and the like. The database can be housed on the medical office system, on a subsystem thereon, or on the central system, for example. For example, the database check and content selection can be performed by or include a patient/physician decision engine that will select and route appropriate content based upon specific medication and product dispensing. When appropriate content is selected, it is then distributed 2206 to the physician or other appropriate user. For example a banner advertisement can be displayed at the kiosk where the prescription is entered or dispensed. Also, a survey relevant to the dispensed medication or product can be distributed to the physician.

Point-of-Sale Subsystem

Since the present system can dispense patient medications and drugs at the physician office, it can collect consumer payment or co-payment at the point-of-sale (POS) for the medications. Thus, the system can include a complete POS subsystem in the physician office. The POS subsystem can include: devices and hardware to process credits cards and debit cards; a device for storing product sales records; a device to print patient receipts and financial reports; and a network connection to the front office server by which sales data and other information is transferred. The POS subsystem can be provided by stand-alone subsystem, integrated into a dispenser unit; incorporated as part of the admission subsystem or provided by any other equivalent means.

FIG. 23 is a task flow diagram of the point-of-sale check out process. At checkout, the subsystem can include a notification list of dispensed medications or products 2302. The subsystem requests selection of a specific patient from the list 2304. The subsystem calculates and displays the amount of payment due from the patient 2306. If no payment is received 2308, the medication is not given to the patient and the medication is returned to the inventory 2310. If payment is received from the patient 2308, a receipt is generated and routed for printing 2312. The transaction record is automatically stored in the subsystem records 2314.

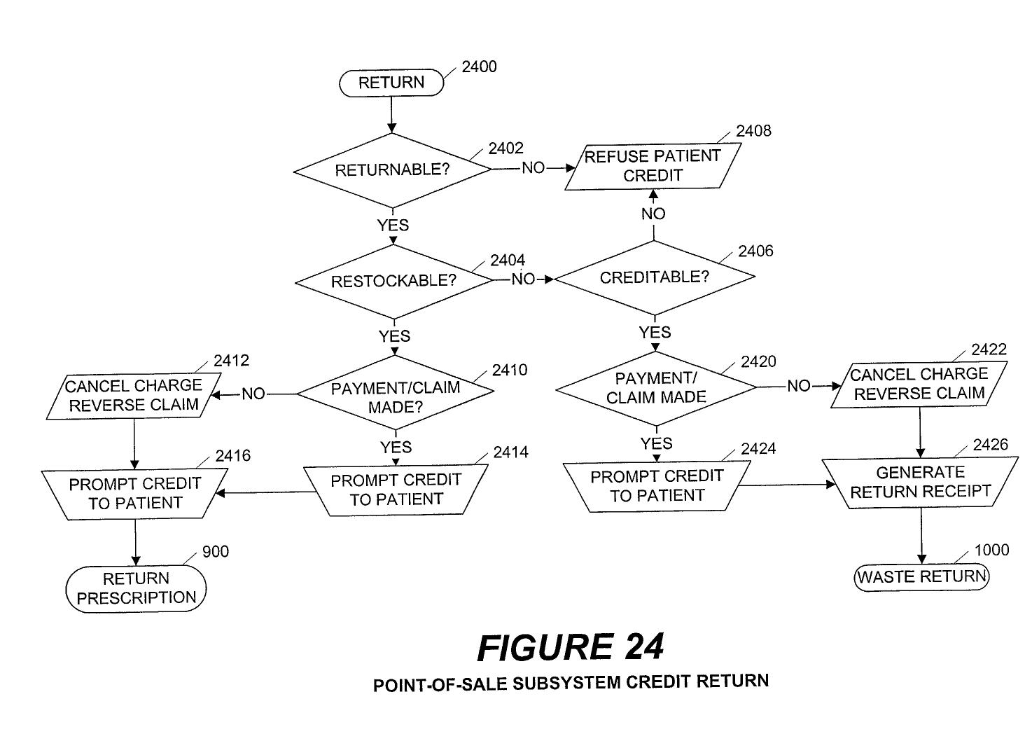

The POS subsystem can also include a credit return process. The return process can seamlessly integrate into physician office workflow facilitating returns with the system. FIG. 24 is a task flow diagram of the point-of-sale credit return process. The subsystem first determines whether the medication or item can be returned 2402. The primary decision of whether a medication is returnable or not can depend upon the policy of the particular medical office. The determination can be based upon factors such as the type of product or medication, whether the container has been opened, etc. If the medication is not returnable, then the patient is refused any credit 2408. If the medication can be returned, the subsystem then determines whether it can be restocked 2404. Generally a medication cannot be restocked if the patient label has been put onto the container. If a medication can be restocked, it can be stored in a return bin until it is returned to the supplier or destroyed.

If the medication cannot be restocked, the subsystem determines whether it is creditable 2406. Whether a medication or product is creditable can be determined by office practice or policy, drug supplier policy, regulation, or any comparable method. If credit cannot be returned 2406, then no credit is returned to the patient 2408. If the medication is creditable 2406 and a payment claim has been made 2420, then the system prompts for credit to the patient 2424, a return receipt is generated 2426 and the product is discarded to waste 1000. If no payment claim has been made 2420, the subsystem cancels the charge and reverses the claim 2422, a return receipt is generated 2426, and the product is discarded to waste 1000.

At 2404, if the product can be restocked, then the system determines whether a payment claims has been made 2410. If a payment claim has been made 2410, then the system prompts credit to the patient 2414, a return receipt is generated 2416 and the product returned 800. If no payment claim has been made 2410, the subsystem cancels the charge and reverses the claim 2412, a return receipt is generated 2416, and the product is discarded to waste 1000.

Pharmacy Adjudication Subsystem

The backend pharmacy adjudication subsystem is another centralized subsystem that processes requests from the front office servers or subsystems at the medical offices. This subsystem can be responsible for performing real-time, online adjudication of pharmacy benefit claims, optionally determining drug utilization results, processing payment transactions, and managing patient histories in a HIPAA-compliant manner. This subsystem can incorporate one or more pharmacy benefit management (PBM) switches to determine the coverage of a particular patient for a specified medication. The results of the adjudication process are returned to the front office server and subsystem at the originating office. In the cases where the adjudication process results in an exception, one of three routes may be followed. According to the first route, the resulting exception information can be returned to the physician office for resolution by office personnel. According to the second route, exceptions can be handled by a specialized home office personnel trained to resolve such issues. According to the third route, the exception can be resolved by electronically forwarding the prescription to a pharmacy of the patient's choosing.

The pharmacy adjudication subsystem also performs checks for adverse drug reactions, drug-drug interactions, and other possible adverse affects potentially caused when providing a patient with specific product. This functionality is configurable by office, physician, or product. The pharmacy adjudication subsystem is also capable of processing electronic payment transactions such as credit card validation.

Enterprise Resource Planning (ERP) Subsystem

The present system utilizes an ERP subsystem to manage the accounting, inventory, purchasing, and fulfillment, and other like aspects of the business. The subsystem can include an accounting module configured to track finances and collection of money. It can include a purchasing module configured to automatically process purchase requests, as well as a fulfillment module configured to manage product order requests. The central office can acquire products from repackagers or manufacturers and can store them in one or more central warehouses. As orders are received from client medical offices, the products can be picked and delivered. The ERP subsystem can handle the logistics of physical and virtual inventory management, reordering, billing, shipping, and other related supply issues. The ERP subsystem can interface with the central server to communicate medical office order requests and fulfillment.

The ERP can include, for example, software and hardware components. For example, a separate ERP server can be used. Also, a system by Oracle can be implemented to accomplish some of the purposes of the subsystem. As an example, a physician writes prescription for patient and the prescription is entered into the system through the prescription subsystem. The prescription is adjudicated and a DUR is performed through the pharmacy adjudication subsystem. The pharmacy adjudication subsystem can route the request through a switch to the appropriate PBM for adjudication. The PBM returns the adjudication response (either reject or paid) back through the pharmacy adjudication system. PBMs can accumulate transactions and remit them once every 2 weeks or once a month, for example. The adjudication response can be received into the subsystem and communicated to the medical office system. If paid, the medication can be dispensed to the patient and the appropriate amount can be collected from the patient. On a nightly basis, for example, dispense and return transactions can be collected from the central server and can be passed to the ERP subsystem and, for example to the Oracle ERP system, for entry against the physician's records. If payment is received for an adjudicated prescription, but the prescription is not dispensed, a reversal can be processed following the same transaction path. Once a prescription is adjudicated as paid, the PBM may assume that the prescribed product was dispensed unless a reverse transaction is received. The ERP can include or interact with a payor reconciliation module to process remittance detail, including unintended payments. The ERP subsystem can also interact with financial institutions, such as banks.

The subsystem can track inventory by inventory owner and sales by inventory owner. As inventory is decreased, replenishment strategies in the subsystem can generate replenishment requests which create pick/pack requests for shipment of medications to the medical office. A third party warehouse can perform the picking and packing, then notify the subsystem that shipment has been made, which in turn decrements the inventory count and increments the physician's inventory count. The medications then can be shipped to the physician office for restocking into the system. The PBM can remit payment for “paid” dispense transactions. The remittance detail can be generally provided on tape format, which is converted and matched to existing receivable records and then loaded into a receivables module. Many of the details described can be implemented on other systems and subsystems.

Reporting

Data capture, data reporting, and information distribution can be aspects of the present system. Turning data into useful information for a wide range of users can be accomplished through the report generator. Due to the extensive reach of the system disclosed herein, there may be a need for certain canned and definable reports. The requirements and breadth of user preferences span, for example, from financial to inventory and order management to regulatory.

Reports can be generated at a number of different access points of the system, such as, a web site, a physician office, and the central office. Each one of these access points may be restricted to a subset of the total number of reports based on its access rights and interaction requirements.

Examples of the report groups that the present system can generate are general business, inventory management, order management, financial management and system activity. Business reports, such as those regarding profitability of dispensed medications, enable the physician to make decisions on whether to carry certain items. Inventory management reports display data such as, the currently available inventory, the location of specific items, and items within certain therapeutic classes. Such information enables both physician and home office staff to track medications through the dispense process. Pharmaceutical representatives can have access to inventory reports regarding sample medications via website access. Order management reports can be included with the ERP and pharmacy adjudication subsystems but may be accessed from other points by authorized users. Information, such as, the date the order was placed, current order status, expected delivery date and order reconciliation are typical of this type of report. Financial management reports can be used to properly conduct central office business. Many of these reports can come from ERP and POS subsystems, but a number of unique financial reports also can be generated. The system activity reports can be made available to a limited number of system personnel. These reports provide detailed information regarding system activity, such as, detailed system access or information regarding access activity. One skilled in the art will understand that many other types and kinds of reports can be generated and utilized by the reporting subsystem.

Training & Learning Subsystems

Even though the design of the present system is intuitive so that minimal training is necessary, system support can provide online tutorials and distance-learning modules. A website can provide learning and training channels that are setup specifically for customers. Furthermore, pharmaceutical companies can have the option of hosting system websites to which physicians can link. Physicians are even able to earn continuing education credit by studying the educational material provided by certain pharmaceutical companies.

Example of a Typical Medication Dispensing Procedure

The following steps can be performed before the medication is dispensed. First, an authorized user logs onto the system and user security is verified. Next, patient information is entered through the admission subsystem so as to create a patient specific drug benefit profile. Payment or co-pay and any other required insurance or PBM information is also entered at that time. The physician or an office staff member can easily perform each of these pre-dispensing tasks from any office kiosk. After the physician has determined the required prescription she need only accesses the system through any convenient kiosk, recall the patient specific drug benefit profile for the specific patient and update it with the appropriate drug information. The prescription subsystem allows the updating process to be done from any computer attached to or otherwise in communication with the office network or the front office server, such as a handheld electronic prescribing unit. Once the patient specific drug benefit profile is updated with the prescription information, this data is transmitted via the front office server to the pharmacy adjudication subsystem and the central server. The pharmacy adjudication subsystem adjudicates the prescription with the patient's PBM and routes any exceptions to the appropriate location. Either the pharmacy adjudication subsystem or the central server screens the medication and patient information for potential drug interactions by performing a DUR. The central server also screens the patient and drug data to determine the appropriateness of all educational, promotional, and legal materials. The results of adjudication and the DUR as well as all appropriate educational, promotional and legal materials are then transmitted to the front office server, which relays this information to the requester and updates the patient's permanent file. The appropriate staff member then approaches the appropriate dispenser unit, and removes the appropriate medication.

The physical dispensing of prescription medications in the physician office does not necessarily require office personnel to break bulk. Rather, bottles of typical therapeutic quantities can be delivered to the medical office. To ensure safe medication practices are followed the system requires the user to follow a specific workflow. The three main components of the dispensing workflow are pulling medication, preparing medication, and verifying medication.

The first step in the procedure requires that the user pull the medication. The system only allows authorized users to pull prescription medications only after appropriate prescription input has taken place. The second step in the procedure requires that the user prepare the medication by placing patient specific labels on each bottle. The final step requires that the user verify that the proper medication has been taken. Prior to completing a dispense transaction, the user is required to verify that the bottle contents, label and prescription information are in agreement.

Dispensing prescription medications in the physician office requires certain regulatory and insurance guidelines to be met. Accordingly, most prescription medications within the physician office require active security, dispensing units that store prescription medications must remain locked at all times. Only during the physical pulling of medications are the units unlocked. Additionally, only a small set of users are granted access to perform prescription dispensing. Such security mechanisms, which are built into the present system, enable the physician office to meet all security regulations while providing a streamlined prescription dispensing workflow.

Examples of System Architecture

FIG. 1 is a representation of a system for medication dispensing and integrated data management. Referring FIG. 1, communication between a server 12 in the medical office 10, the pharmacy adjudication subsystem 32 and the ERP subsystem 36 can be provided through a secure Internet connection 50. The Internet connection 50 also links the central server 30 to each of the above servers. Preferably, a large number of physician offices, each having its own front office server 12, communicate with the central server 30 and the pharmacy adjudication subsystem 32 via the Internet 50.

Alternatively, the front office server 12 further, can communicate with other physician office computers 14 through a local network connection. The physician office network includes the front office server 12, and a computer or computers which can accept patient and prescription information and serve as a point-of-sale subsystem. One skilled in the art will immediately recognize that front office servers 12 can act as a point-of-sale subsystem, a data entry subsystem that accepts both patient and prescription information or even perform all of the combined functions of the physician office computer network 10.

Further, one or more networked computers are capable of communicating with one or more or the dispenser units 24 in the physician office. Communication may be facilitated through a local area network (LAN), the Internet, radio frequency transmissions, or similar means. Dispensing of medication can either occur automatically when a dispense command or control signal is received by the appropriate dispenser unit from one of the networked computers (and subsystems thereon) or manually when an authorized system user accesses a dispenser unit to physically remove the appropriate medication.

While this invention has been particularly shown and described with references to preferred embodiments thereof, it will be understood by those skilled in the art that various changes in form and details may be made therein without departing from the spirit and scope of the invention. Those skilled in the art will recognize or be able to ascertain using no more than routine experimentation, many equivalents to the specific embodiments of the invention described specifically herein.

What is claimed is:

1. A medical system for integrating data management with the process of controllably dispensing products including medications, the system comprising:
one or more dispensers configured to controllably release a product in response to a control signal;
an admission subsystem configured to maintain patient information; and
a prescription subsystem coupled to said one or more dispensers and configured to receive entry of prescription information, to relate patient information from said admission subsystem to the prescription information to initiate a determination of whether the product is appropriate for the patient, and to send a control signal to said one or more dispenser units to release the product.

2. The system of claim 1, wherein said determination of whether the medication is appropriate for the patient comprises a pharmacy adjudication.

3. The system of claim 1, wherein said determination of whether the medication is appropriate for the patient comprises a drug utilization review (DUR).

4. The system of claim 1, wherein said prescription subsystem is further configured to manage and control a virtual inventory by tracking ownership and utilization of a plurality of individually owned and co-mingled inventories in said one or more dispensers.

5. The system of claim 4, wherein access to a medication in inventory is further controlled according to ownership of the medication as tracked in said virtual inventory.

6. The system of claim 1, wherein said prescription subsystem is configured to manage and control a physical inventory by sending a reorder message to reorder a product when an inventory level is at a predefined level.

7. The system of claim 6, wherein the predefined level comprises a par inventory level.

8. The system of claim 6, wherein the predefined level comprises a dynamic par level that is based upon medical office product usage data.

9. The system of claim 1, wherein said admission subsystem generates a patient specific drug benefit profile used in prescribing the medication.

10. The system of claim 1, further comprising a sample management subsystem configured to track the distribution of a sample medication to a patient, to associate information gathered from the distribution of the sample medication with said patient information, to initiate a determination of whether the medication is appropriate for the patient, and to send a control signal to said one or more dispenser units to release a sample medication.

11. The system of claim 1, further comprising, a patient care subsystem configured to relate said patient information to data collected from the dispensing of an office administered medication and to send a control signal to said one or more dispenser units to release a product.

12. The system of claim 1, further comprising an over-the-counter subsystem configured to relate said patient information to data collected from the dispensing of an over the counter product, further configured to send a control signal to said one or more dispenser units to release the over the counter product.

13. The system of claim 1, wherein the medication is dispensed at the point of care.

14. The system of claim 1, further comprising a central server connected via a network to said prescription subsystem and configured to receive and process said determination of whether the medication is appropriate for the patient.

15. The system of claim 14, wherein said central server is coupled to an enterprise resource planning system having an accounting module configured to track finances and collection of money, an inventory module configured to manage physical and virtual product inventories, a purchasing module configured to automatically process purchase requests, and a fulfillment module configured to manage product order requests.

16. A medical product dispensing system for integrating data management with the process of controllably dispensing medical products at the point of care, comprising:
one or more dispensers configured to controllably grant access to a product in response to a control signal;
an admission subsystem configured to collect and maintain patient information;
a prescription subsystem for receiving entry of prescription information, for relating patient information from said admission subsystem to the prescription information to initiate a determination of whether the medication is appropriate for the patient, and for sending a control signal to said one or more dispenser units to release a product;
a sample management subsystem configured to track the distribution of a sample medication to a patient, to associate information gathered from the distribution of the sample medication with said patient information to initiate a determination of whether the sample medication is appropriate for the patient, and to send a control signal to said one or more dispenser units to grant access to the sample medication;
a marketing subsystem configured to associate said patient information with said information from at least one other subsystem thereby determining appropriate marketing information to transmit; and
a point of sale subsystem configured to manage payment information.

17. The medical product dispensing system of claim 16, wherein said sample management subsystem is further configured to relate patient information from said admission subsystem to the prescription information and to initiate a drug utilization review (DUR) to determine whether the sample medication is appropriate for the patient.

18. The medical product dispensing system of claim 17, further comprising a central server connected via a network to said prescription subsystem, said sample management subsystem, and said marketing subsystem and further configured to receive and process said determination of whether the medication is appropriate for the patient.

19. The medical product dispensing system of claim 18, wherein said central server is configured to receive and process a drug utilization review (DUR).

20. The medical product dispensing system of claim 18, wherein said central server is configured to maintain data or information in a database, and said central server is coupled to an information distribution subsystem that is configured to generate and display reports from said data to users.

21. The medical product dispensing system of claim 16, further comprising physical and virtual inventory control and management.

22. A medication dispenser for integrating data management with the process of controllably dispensing a product at the point of care, comprising:
one or more product cabinets configured to controllably release a product in response to a control signal from a prescription subsystem;
an admission subsystem configured to collect patient information; and
a prescription subsystem configured to receive entry of prescription information and to relate the patient information to the prescription information to initiate a determination of whether the product is appropriate for the patient, further configured to transmit a control signal to the one or more product cabinets to permit access to the product.

23. The medication dispenser of claim 22, further comprising a marketing subsystem configured to track and report use of the product and to associate said patient information with said use of the product thereby determining appropriate marketing information to direct to an individual dispensing the product and/or said patient.

24. A system for integrating data management with the process of dispensing a sample medication, comprising:
one or more dispensers configured to controllably release a sample medication in response to a control signal from a sample management subsystem;
an admission subsystem configured to collect patient information; and
a sample management subsystem configured to determine a sample medication for a patient and to track sample medication usage, and to transmit a dispense signal to the one or more dispenser units.

25. The system of claim 24, wherein said sample management subsystem further is configured to initiate a drug utilization review of the sample medication prior to transmitting a dispense signal to the one or more dispenser units.

26. The system of claim 24, wherein said sample management subsystem further is configured to track dispensing of said sample medication and to compile and provide sample usage reports to a user.

27. The system of claim 24, further comprising a marketing subsystem configured to track and report the use of the sample medication and to associate said patient information with said use of the sample medication thereby determining appropriate marketing and educational information to direct to an individual dispensing the sample medication and/or said patient.

28. The system of claim 24, comprising a central server connected via a network to said sample management subsystem, wherein said central server receives tracked sample medication usage information from said sample management subsystem and wherein said central server makes said sample management usage information available to an authorized user.

29. The system of claim 28, wherein said authorized user is a pharmaceutical company representative.

30. The system of claim 28, wherein said authorized user is a medication supplier.

31. A system for integrating data management with the process of dispensing products at the point of care, comprising:
a patient information database configured to maintain patient information;
one or more dispensers configured to dispense a product in response to a control signal from a prescription module; and
a prescription module to receive a prescription for the product and to initiate an adjudication check for the product utilizing said patient information, further to transmit the control signal to said one or more dispensers to release the product.

32. The system of claim 31, further comprising an inventory management module to control and manage the inventory of the product.

33. The system of claim 32, wherein said prescription module further manages and controls a virtual inventory by tracking ownership and utilization of a plurality of individually owned but co-mingled inventories in said one or more dispensers.

34. The system of claim 33, wherein the product is released to a user in response to the control signal based upon the user having product in virtual inventory.

35. A system for integrating data management with the process of controllably dispensing products at the point of care, comprising:
a patient information database configured to maintain patient information;
one or more dispensers configured to controllably dispense a product in response to a control signal from a prescription module; and
a prescription module to receive a prescription for the product and to initiate an adjudication check for the product utilizing said patient information, further to transmit the control signal to said one or more dispensers to release the product; and
an inventory management module to control and manage the inventory of the product.

36. The system of claim 35, wherein said inventory management module is configured to control and manage a physical inventory and a virtual inventory for the product.

37. The system of claim 36, wherein said inventory management module is configured to manage and control said virtual inventory by tracking ownership and utilization of a plurality of individually owned and co-mingled product inventories in said one or more dispensers.

38. The system of claim 37, wherein access to a product in inventory is further controlled according to ownership of the product as tracked in said virtual inventory.

39. The system of claim 36, wherein said inventory management module is configured to manage and control a physical inventory by sending a reorder message to reorder a product when an inventory level is at a predefined level.

40. The system of claim 39, wherein the predefined level comprises a par inventory level.

41. The system of claim 40, wherein the predefined level comprises a dynamic par level that is based upon medical office product usage.

42. The system of claim 39, further comprising a central server connected via a network to said inventory management module, and said central server is connected to an ERP subsystem that is configured to receive and process the reorder message.

43. A system for dispensing a medical product and for controlling a virtual inventory comprising:
one or more dispensers to controllably release a medical product in response to a control signal; and
a prescription subsystem configured to manage and control a co-mingled physical inventory of a plurality of individually owned medical products and to send a dispense signal to said one or more dispensers to release a medical product to a user based upon the user having the medical product in a virtual inventory.

44. A medical system for integrating data management with the process of controllably dispensing a product, including a medication, the system comprising:
one or more dispensers configured to controllably release a product in response to a control signal;
an admission subsystem configured to maintain patient information;
a prescription subsystem coupled to said one or more dispensers and configured to receive prescription information, to relate patient information from said admission subsystem to the prescription information, to initiate a pharmacy adjudication request, and to send a control signal to said one or more dispenser units to release a product; and
a central system comprising a central server connected via a network to said prescription subsystem and configured to receive and process the pharmacy adjudication request.

45. The system of claim 44, wherein said central system comprises an enterprise resource planning subsystem coupled to said central server and said enterprise resource planning subsystem having an accounting module configured to track finances and collection of money, an inventory module configured to manage physical and virtual product inventories, a purchasing module configured to automatically process purchase requests, and a fulfillment module configured to manage product order requests.

46. The system of claim 44, wherein said central system comprises a pharmacy subsystem, wherein said pharmacy system is configured to adjudicate a pharmacy adjudication request.

47. The system of claim 44, wherein said central system comprises a support subsystem connected to said central server, wherein said support subsystem is configured to manage and control user training and learning modules.

48. The system of claim 44, wherein said central system comprises a website connected to said central server, wherein said website is configured to provide controlled user access to system information.

49. The system of claim 48, wherein said system information is selected from the group consisting of a financial report, an inventory report, a usage report, a regulatory report, a sales report, an order management report, and a business report.

50. The system of claim 44, further comprising a front office server coupled to said one or more dispensers and comprising said admission subsystem and said prescription subsystem, said front office server configured to serve patient information.

51. The system of claim 44, wherein said central server is configured to provide content to a marketing subsystem.

52. The system of claim 44, wherein said central system performs system maintenance and monitoring.

53. A method for dispensing a medical product at the point of care comprising:
receiving a prescription request for a medical product for a patient;
transmitting the prescription request for adjudication by comparing patient information with prescription information for the medical product to determine whether the medical product is appropriate for the patient;
releasing said medical product from a controlled dispenser; and
sensing removal of the medical product from the controlled dispenser.

54. The method of claim 53, further comprising verifying that the correct medical product is taken.

55. The method of claim 53, further comprising manually sending refill information to a pharmacy or medical product supplier.

56. The method of claim 53, further comprising electronically sending refill information to a pharmacy or medical product supplier.

57. A method for controllably dispensing a medication and integrating data management comprising:
receiving a prescription for a medication;
initiating an adjudication check, said adjudication check comprising comparing patient information with prescription information for the medication to determine whether the medication is appropriate for the patient;
providing clinical or marketing information related to the prescription to a user or the patient;
making said medication available to the user;
sensing the taking of the medication; and
verifying that the correct medication is dispensed.

58. The method of claim 57, wherein the sensing the taking comprises electronically sensing the taking of the medication.

59. The method of claim 57, wherein verifying that the correct medication is taken comprises receiving medication package information and comparing said medication package information to stored information on the system.

60. The method of claim 57, wherein the medication information is received by scanning a bar code on the medication package.

61. A method for dispensing a medical product and integrating data management comprising:
receiving a request for a medical product;
providing clinical or marketing information related to the request to a user or a patient;
making said medical product available to the user;
sensing the taking of the medical product from a controlled dispenser; and
verifying that the correct medical product is taken from the controlled dispenser.

62. The method of claim 61, further comprising initiating an adjudication check, said adjudication check comprising comparing patient information with request information for the medical product to determine whether the medical product is appropriate for the patient.

63. A method for inventory management and control of a plurality of individually owned product that is co-mingled in a controlled dispenser unit, comprising:
storing in a controlled dispenser unit a plurality of individually owned product for more than one inventory owner;
receiving inventory data for each individual inventory owner;
tracking the dispensing of a product owned by the individual inventory owner from the controlled dispenser unit;
updating the inventory data; and
controllably dispensing the product based upon the inventory data for the individual inventory owner.

64. A method for controlling access to a plurality of individually owned product that is co-mingled based upon virtual inventory, comprising:
storing together in a controlled dispenser a plurality of individually owned product for more than one inventory owner;
tracking the inventory level of the individually owned product for each inventory owner;
granting access to an individual inventory owner to a product based upon the inventory level of the individual inventory owner.

65. A method for providing information used in prescribing a medication at the point of care using a patient specific benefit profile, the method comprising:
generating a patient specific drug benefit profile integrating patient specific information, benefit profile, and inventory status; and
displaying said patient specific benefit profile to a user.

66. The method of claim 65, wherein said patient specific drug benefit profile is displayed on a handheld computer, a printout, a desktop computer, or a laptop computer.
